(19) United States
(12) Patent Application Publication
(10) Pub. No.: US 2025/0371653 A1
(43) Pub. Date: Dec. 4, 2025

(54) DEVICE AND METHOD FOR IMAGE WARPING

(71) Applicant: Synaptics Incorporated, San Jose, CA (US)

(72) Inventors: Tomoo Minaki, Tokyo (JP); Hirobumi Furihata, Tokyo (JP); Kazutoshi Aogaki, Kanagawa (JP)

(21) Appl. No.: 19/089,898

(22) Filed: Mar. 25, 2025

Related U.S. Application Data
(60) Provisional application No. 63/654,358, filed on May 31, 2024.

(51) Int. Cl. G06T 3/18; G06T 3/04

(52) U.S. Cl. CPC G06T 3/18; G06T 3/04

(57) ABSTRACT

A display driver includes an image warping circuit and drive circuitry. The image warping circuit performs image warping processing on input image data corresponding to an input image to generate resulting image data corresponding to a resulting image. The image warping processing may include determining first and second ratios corresponding to a target pixel in a quadrangular target cell defined in the resulting image, wherein the target pixel is located at an intersection of a first line segment that divides a first pair of opposing sides of the target cell according to the first ratio and a second line segment that divides a second pair of opposing sides of the target cell according to the second ratio. Pixel data of the target pixel may be determined based on pixel data of one or more pixels selected from pixels of the input image based on the first and second ratios.

### CROSS REFERENCE TO RELATED APPLICATIONS

This application claims benefit under 35 U.S.C. § 119(e) to U.S. Provisional Patent Application Ser. No. 63/654,358, filed on May 31, 2024, which is incorporated herein by reference in its entirety.

### TECHNICAL FIELD

This disclosure relates generally to image processing and more particularly to image warping performed with reduced hardware and/or software resources.

### BACKGROUND

Some display devices may be configured to display images on a curved display screen. One example is head-up displays (HUD) mounted on automotive vehicles. An automotive HUD may be configured to use a curved windshield as a display screen to present information that assists in driving the automotive vehicle, such as the speed of the automotive vehicle and navigation information. In other examples, a large panel display device, such as liquid crystal display (LCD) devices and organic light emitting diode (OLED) displays, may be configured to display images on a curved display panel.

One problem with using a curved display screen is that the user may perceive distorted images. For example, if an automotive HUD is configured to project a rectangular image onto a curved windshield, the user (e.g., the driver) may perceive a non-rectangular image with concave or convex sides. The image distortion caused by the curvature of the display screen may be undesirable for the user to properly extract information from the image. For example, if a map is displayed on the display screen with distortion caused by the curvature of the display screen, it may prevent the user from correctly deriving location information from the displayed map. Accordingly, there is a technical need to mitigate the effects of image distortion that may be caused by the curved display screen.

### SUMMARY

This summary is provided for the purpose of introducing, in a simplified form, a selection of concepts that will be further described below. This summary is not necessarily intended to identify key features or essential features of the present disclosure. The present disclosure may include the following various aspects and embodiments.

In general, in one aspect, this disclosure provides a display driver that includes an image warping circuit and drive circuitry. The image warping circuit is configured to perform image warping processing on input image data corresponding to an input image to generate resulting image data corresponding to a resulting image. The drive circuitry is configured to drive a display panel based on the resulting image data. Performing the image warping processing may include determining a first ratio and a second ratio corresponding to a target pixel in a quadrangular target cell defined in the resulting image, wherein the target pixel is located at an intersection between a first line segment and a second line segment. The first line segment connects a first point on a first side of the target cell and a second point on a second side of the target cell opposite the first side, wherein the first point divides the first side according to the first ratio and the second point divides the second side according to the first ratio. The second line segment connects a third point on a third side of the target cell and a fourth point on a fourth side of the target cell opposite the third side, wherein the third point divides the third side according to the second ratio and the fourth point divides the fourth side according to the second ratio. Performing the image warping processing may further include determining pixel data of the target pixel based on pixel data of one or more pixels selected from pixels of the input image selected based on the first ratio and the second ratio.

In another aspect, performing the image warping processing may include defining a target grid that divides the resulting image into a plurality of first cells and defining a source grid that divides the input image into a plurality of second cells that correspond to the plurality of first cells, respectively. Performing the image warping processing may further include determining positions of intersection points between the target grid and a horizontal line in which a target pixel of the resulting image is located and storing intersection point information that indicates the positions of the intersection points in a storage. Performing the image warping processing may further include identifying a target cell in which the target cell is located from the plurality of first cells based on the intersection point information, and determining pixel data of the target pixel based on pixel data of the input image data for one or more pixels in a source cell of the plurality of first cells corresponding to the target cell.

In another aspect, this disclosure provides a method for driving a display panel. The method includes performing image warping processing on input image data corresponding to an input image to generate resulting image data corresponding to a resulting image. The method further includes driving the display panel based on the resulting image data. Performing the image warping processing includes determining a first ratio and a second ratio corresponding to a target pixel in a quadrangular target cell defined in the resulting image, wherein the target pixel is located at an intersection between a first line segment and a second line segment. The first line segment connects a first point on a first side of the target cell and a second point on a second side of the target cell opposite the first side, the first point dividing the first side according to the first ratio, the second point dividing the second side according to the first ratio. The second line segment connects a third point on a third side of the target cell and a fourth point on a fourth side of the target cell opposite the third side, the third point dividing the third side according to the second ratio, the fourth point dividing the fourth side according to the second ratio. The method further includes determining pixel data of the target pixel based on pixel data of one or more pixels selected from pixels of the input image selected based on the first ratio and the second ratio.

Other features and aspects are described in more detail below with reference to the attached drawings.

### BRIEF DESCRIPTION OF THE DRAWINGS

FIG. 1 shows an example display system, according to one or more embodiments.

FIG. 2 shows an example of image warping for correcting image distortion caused by a curvature of a display screen, according to one or more embodiments.

FIG. 3 shows an example process of image warping, according to one or more embodiments.

FIG. 4 shows an example of generating a target cell of a warped image from a source cell of the input image, according to one or more embodiments.

FIG. 5A shows an example configuration of a projector system, according to one or more embodiments.

FIG. 5B shows an example configuration of a display panel, according to one or more embodiments.

FIG. 6 shows examples of an input image and a resulting image generated by performing image warping processing, according to one or more embodiments.

FIG. 7 shows an example configuration of an image warping circuit, according to one or more embodiments.

FIG. 8 shows an example identification of a target cell and its corresponding source cell, according to one or more embodiments.

FIG. 9 shows an example calculation of the xy coordinates of a target pixel corresponding position in an input image, according to one or more embodiments.

FIG. 10 shows an example process for calculating a ratio a:b, according to one or more embodiments.

FIGS. 11A to 11E show example iterations for calculating the ratio a:b, according to one or more embodiments.

FIG. 12 shows an example process for calculating a ratio c:d, according to one or more embodiments.

FIG. 13 shows an example determination of the ratios a:b and c:d, according to one or more embodiments.

FIG. 14 shows an example configuration of a pixel mapping circuit, according to one or more embodiments.

FIG. 15 shows an example of cell identification in generating resulting image data for the N-th horizontal line of the resulting image, according to one or more embodiments.

FIG. 16 shows an example of target cell identification based on cross products, according to one or more embodiments.

FIG. 17 shows an example cell identification method, according to one or more embodiments.

FIG. 18 shows an example configuration of a cell identification circuit, according to one or more embodiments.

FIG. 19 shows an example process, according to one or more embodiments.

For ease of understanding, where possible, identical reference numerals have been used to designate elements that are common to the figures. It is contemplated that elements disclosed in one embodiment may be utilized in other embodiments without specific recitation. Suffixes may be appended to reference numerals to distinguish elements from one another. The drawings referenced herein are not to be construed as being drawn to scale unless specifically noted. In addition, the drawings are often simplified and details or components are omitted for clarity of presentation and explanation. The drawings and discussion are intended to explain the principles discussed below.

### DETAILED DESCRIPTION

The following detailed description is exemplary in nature and is not intended to limit the disclosure or the applications and uses of the disclosure. Further, there is no intention to be bound by any expressed or implied theory presented in the preceding background, summary and brief description of the drawings, or in the following detailed description.

In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

The term “coupled” as used herein means connected directly to or connected through one or more intervening components or circuits. Further, ordinal numbers (e.g., first, second, third, etc.) may be used throughout the application as an adjective for an element (i.e., any noun in the application). The use of ordinal numbers is not intended to imply or create any particular ordering of the elements nor is it intended to limit any element to being only a single element unless expressly disclosed, such as by the use of the terms “before”, “after”, “single”, and other such terminology. Rather, the use of ordinal numbers is intended to distinguish between the elements. By way of an example, a first element is distinct from a second element, and the first element may encompass more than one element and succeed (or precede) the second element in an ordering of elements.

Some display devices may be configured to display images on a curved display screen. For example, an automotive HUD may be configured to use a curved windshield as a display screen and present various information that assists in driving the automotive vehicle, such as the speed of the automotive vehicle and navigation information, on the curved windshield to allow the driver to view the presented information with reduced eye movements. In other examples, a large-size panel display device, such as liquid crystal display (LCD) devices and organic light emitting diode (OLED) display devices, may be configured to display images on a curved display panel.

However, displaying images on a curved display screen may cause the user to perceive distorted images. For example, if an automotive HUD is configured to project a rectangular image onto a curved windshield, the user (e.g., the driver) may observe a distorted non-rectangular image with concave or convex sides. The image distortion caused by the curvature of the display screen may be undesirable for the user to properly extract information from the image. For example, if a map is displayed on the curved windshield with distortion, this may prevent the user from correctly deriving location information from the displayed map.

One countermeasure to image distortion caused by the curvature of the display screen is to use image warping, which is a type of image processing that corrects the image distortion through a geometric transformation. In automotive HUD applications, for example, it may be advantageous to implement image warping to produce warped images that compensate for the curvature of the windshield so that the driver can clearly see the corrected images from any angle.

However, image warping may require complex computation, which may result in increased hardware/software resources, increased power consumption, and decreased processing speed. In one implementation, image warping may involve defining a grid over an input image to divide the input image into quadrangular cells and applying a homography transformation (or projective transformation) to each cell. While the homography transformation is based on a coordinate transformation using a transformation matrix, computing the elements of the transformation matrix may require computing an inverse matrix of a high order matrix (e.g., an 8×8 matrix) or solving complex simultaneous equations for each cell, which may undesirably increase the computational costs, such as hardware resources and/or software resources and power consumption. The present disclosure provides various techniques for implementing image warping with an efficient algorithm and/or reduced resources (e.g., without performing a homography transformation or solving complex simultaneous equations and/or without using a central processing unit (CPU) or a graphical processing unit (GPU)), which may result in a smaller circuit size and/or low power design.

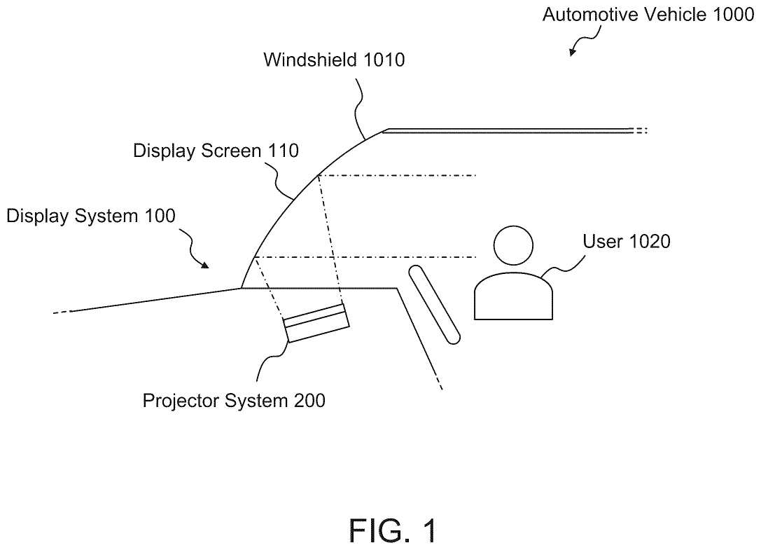

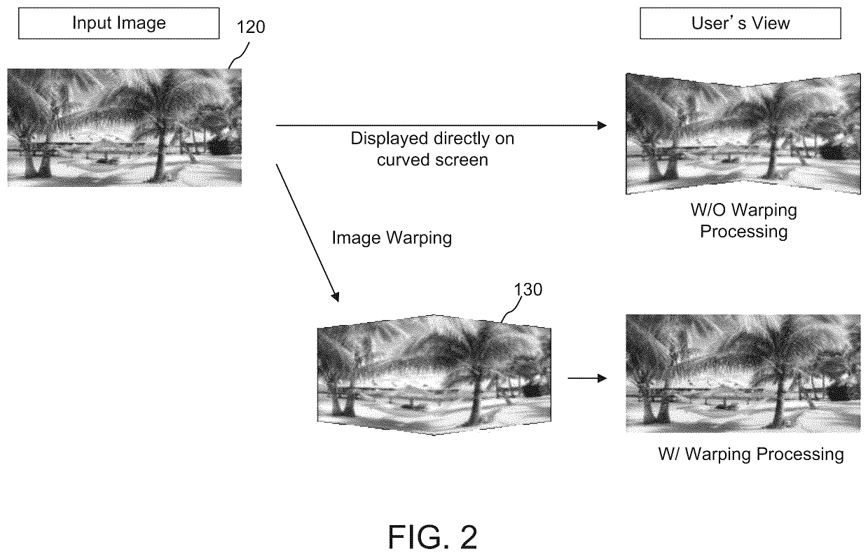

FIG. 1 shows an example display system, denoted by numeral 100, according to one or more embodiments. The display system 100 is configured as an automotive head-up display (HUD) used in an automotive vehicle 1000. In the shown embodiment, the display system 100 uses a portion of a curved windshield 1010 of the automotive vehicle 1000 as a display screen 110 and includes a projector system 200 configured to project an image onto the display screen 110 from inside of the automotive vehicle 1000. In the shown embodiment, the windshield 1010 is convex toward the front of the automotive vehicle 1000, and, therefore, the display screen 110 is concavely curved as viewed by a user 1020 of the display system 100 (e.g., a driver of the automotive vehicle 1000). Accordingly, when the projector system 200 projects an original rectangular image onto the display screen 110 as shown in FIG. 2, the user 1020 of the display system 100 will observe a distorted image with a non-rectangular image having concave sides on the display screen 110. The image distortion may prevent the user 1020 from properly extracting visual information from the displayed image on the display screen 110, thereby degrading the user experience.

In one or more embodiments, the display system 100 may be configured to correct the image distortion potentially caused by the curvature of the display screen 110 through image warping, as shown in the lower portion of FIG. 2. In the shown embodiment, the display system 100 is configured to perform image warping on an input image 120 to produce a corrected or warped image 130. The image warping may be performed to compensate for the curvature of the display screen 110 such that the image distortion is corrected when the warped image 130 is displayed on the display screen 110 by the projector system 200. It should be noted that although the embodiments described above are based on the projector system 200 for an automotive HUD application, the present disclosure may be applicable to any display system having a curved display screen.

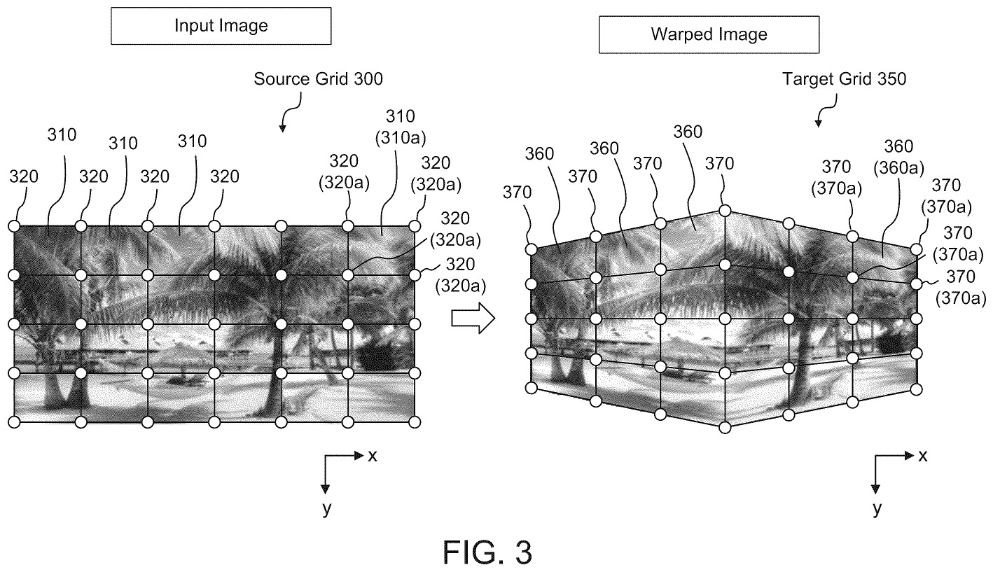

FIG. 3 shows an example process of image warping, according to one or more embodiments. In one or more embodiments, the image warping is based on a source grid 300 defined for the input image and a target grid 350 defined for the warped image. The source grid 300 includes a set of nodes 320 and line segments each coupling two of the nodes 320, and divides the input image into quadrangular cells (or polygons) 310. Similarly, the target grid 350 includes a set of nodes 370 and line segments each coupling two of the nodes 370, and divides the warped image into quadrangular cells 360. Each cell 310 of the input image is defined by four nodes 320 of the source grid 300 which are located at the corners (or vertices) of that cell 310, while each cell 360 of the warped image is defined by four nodes 370 of the target grid 350 which are located at the corners of that cell 360. For example, the top right cell 310a of the input image is defined by the four nodes 320a located at the corners of the top right cell 310a, while the top right cell 360a of the warped image is defined by the four nodes 370a located at the corners of the top right cell 360a. The cells 310 of the input image correspond one-to-one to the cells 360 of the warped image. The image warping processing produces each cell 360 of the warped image by deforming the corresponding cell 310 of the input image. For example, the image warping may produce the top right cell 360a of the warped image by deforming the top right cell 310a of the input image. In one or more embodiments, an xy coordinate system is defined for each of the input image and the warped image, where the x coordinate indicates the horizontal location in the input image or the warped image, and the y coordinate indicates the vertical location in the input image or the warped image.

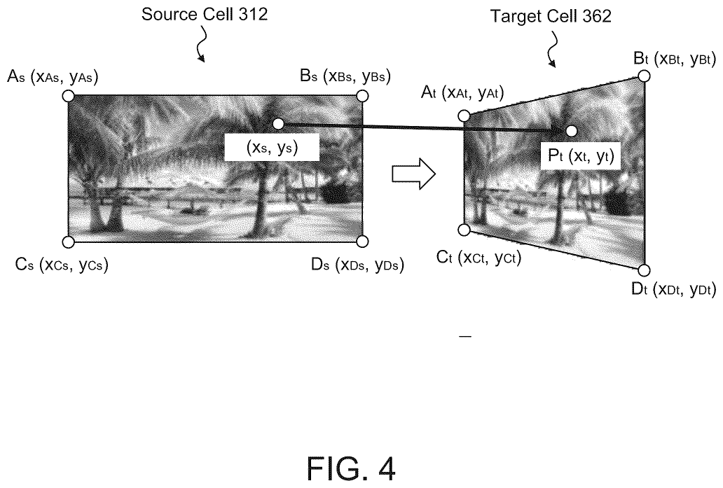

FIG. 4 shows an example of generating a target one of the cells 360 (hereinafter simply referred to as “target cell 362”) of the warped image from the corresponding cell 310 (hereinafter simply referred to as “source cell 312”) of the input image, according to one or more embodiments. In FIG. 4, As, Bs, Cs, and Ds are the four nodes that define the source cell 312 (i.e., the corners of the source cell 312), while At, Bt, Ct, and Dt are the four nodes that define the target cell 362 (i.e., the corners of the target cell 362). In one or more embodiments, the pixel data of a target pixel Pt located at the xy coordinates (xₜ, yₜ) in the target cell 362 is calculated as follows. It is noted that the target pixel Pt is a pixel of the warped image for which pixel data is currently to be generated by the image warping processing. First, the xy coordinates (xₛ, yₛ) of the position in the input image corresponding to the position of the target pixel Pt are calculated based on the xy coordinates (xₜ, yₜ) of the target pixel Pt, the xy coordinates of the corners As, Bs, Cs, and Ds of the source cell 312, and the xy coordinates of the corners At, Bt, Ct, and Dt of the target cell 362. This is followed by selecting one or more pixels of the source cell 312 located at or near the xy coordinates (xₛ, yₛ), and determining the pixel data of the target pixel Pt based on the pixel data of the selected one or more pixels. In some embodiments, one pixel of the source cell 312 (e.g., the pixel located at or closest to the xy coordinates (xₛ, yₛ)) is selected based on the xy coordinates (xₛ, yₛ), and the pixel data of the target pixel Pt is determined to be equal to the pixel data of the selected pixel. In other embodiments, multiple pixels (e.g., four pixels) of the source cell 312 closest to the xy coordinates (xₛ, yₛ) are selected and the pixel data of the target pixel Pt is determined by interpolating the pixel data of the selected pixels based on the xy coordinates (xₛ, yₛ). The present disclosure provides various technologies for implementing the above-described image warping with an efficient algorithm and/or reduced hard resources.

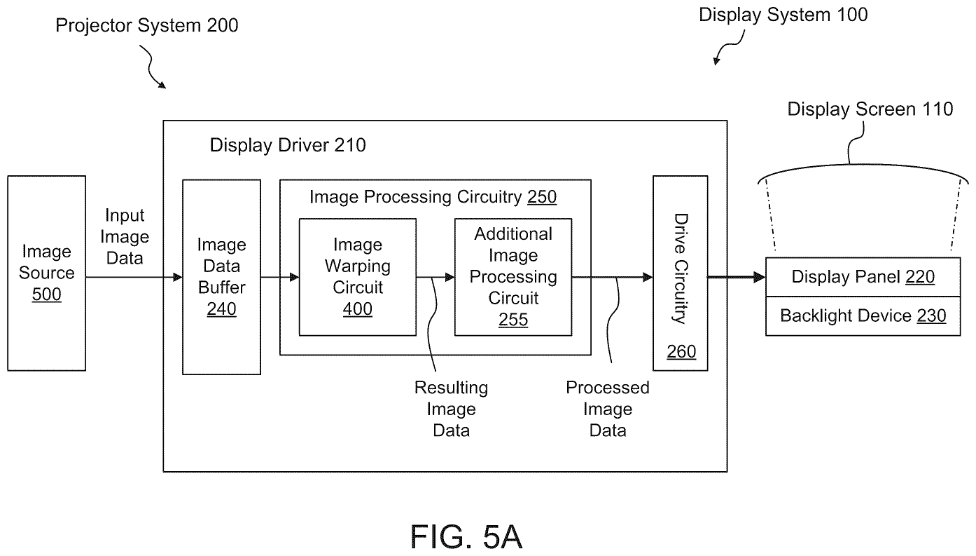

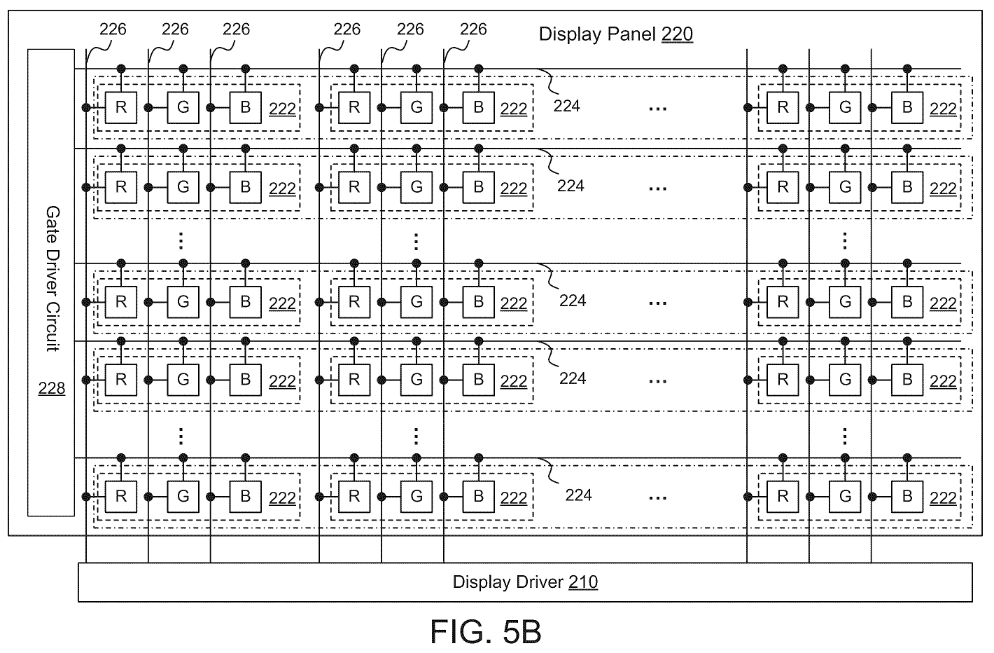

FIG. 5A shows an example configuration of the projector system 200 of the display system 100, according to one or more embodiments. In the shown embodiment, the projector system 200 includes a display driver 210, a transmissive display panel 220, and a backlight device 230. The display driver 210 may be configured as a display driver integrated circuit (DDIC), and the transmissive display panel 220 may be a transmissive LCD panel. The display driver 210 includes an image data buffer 240, image processing circuitry 250, and drive circuitry 260. The image data buffer 240 is configured to receive input image data corresponding to the input image (e.g., the input images shown in FIGS. 2 and 3) from an image source 500 and store the input image data therein. The image source 500 may be an application processor, a central processing unit (CPU), a graphics processing unit (GPU), a digital signal processor (DSP), a micro controller unit (MCU), or any other type of processor configured to generate the input image data. The image processing circuitry 250 is configured to retrieve the input image data from the image data buffer 240 and apply image processing to the input image data to generate processed image data. The drive circuitry 260 is configured to drive the display panel 220 based on the processed image data. The backlight device 230 is configured to illuminate the transmissive display panel 220, and the light passing through the display panel 220 forms a display image on the curved display screen 110, which is a part of the windshield as described in relation to FIG. 1.

FIG. 5B shows an example configuration of the display panel 220, according to one or more embodiments. In the shown embodiments, the display panel 220 includes an array of pixels 222, a plurality of gate lines (also referred to as “scan lines”) 224, a plurality of source lines (also referred to as “data lines”) 226, and a gate driver circuit 228. Each pixel 222 may include a red (R) subpixel, a green (G) subpixel, and a blue (B) subpixel, indicated in FIG. 5B by the boxes with the letters “R”, “G”, and “B”, respectively. Each subpixel may be located at an intersection of a respective gate line 224 and a respective source line 226 and coupled to the respective gate line 224 and the respective source line 226. Each subpixel is driven by the display driver 210 via the respective source line 226. In other embodiments, each pixel 222 may further include a subpixel of another color (e.g., yellow and white) other than red, green, and blue.

Referring back to FIG. 5A, in one implementation, the image processing circuitry 250 includes an image warping circuit 400 configured to perform image warping processing on the input image data, which corresponds to the input image, to generate resulting image data that represents a resulting image. The input image data includes pixel data of the respective pixels of the input image, and the resulting image data includes pixel data of the respective pixels of the resulting image. In embodiments where the pixels 222 of the display panel 220 include R, G, and B subpixels, the pixel data of each pixel of the input image and the resulting image may include red (R), green (G), and (B) graylevels of the pixel, where the R, G, and B graylevels may indicate the luminance levels of the R, G, and B subpixels, respectively. In other embodiments, additional image processing may be applied to the input image data and the image warping circuit 400 may be configured to perform the image warping processing on the image data generated by the additional image processing to generate the warped image data.

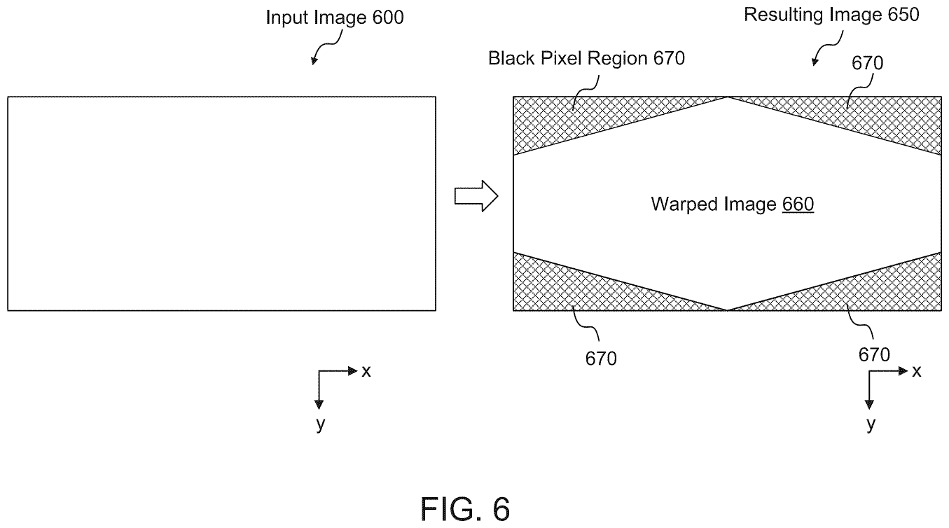

FIG. 6 shows examples of an input image 600 and a resulting image 650 generated by performing the image warping processing, according to one or more embodiments. The resulting image 650 includes a warped image 660 generated by performing image warping on the input image 600. In one or more embodiments, the image warping may be performed such that the image distortion of the display image on the curved display screen 110 (shown in FIGS. 1 and 5A) is mitigated or eliminated by projecting the warped image 660 onto the curved display screen 110. To facilitate the image processing, the resulting image 650 may be formed as a rectangular image by additionally including one or more black pixel regions 670 filled with “black pixels”. As used herein, a “black pixel” is a pixel with zero luminance. In implementations where pixel data for respective pixels of the resulting image data include R, G, and B graylevels, the “black pixel” may be a pixel for which the R, G, and B graylevels are all zero. The one or more black pixel regions 670 are defined to fill the portion of the resulting image 650 other than the warped image, such that the warped image 660 and the one or more black pixel regions 670 form the rectangular shape of the resulting image 650. In the shown embodiments, four black pixel regions 670 are positioned at the corners of the resulting image 650. The resulting image data representing the resulting image 650 may include pixel data of respective pixels of the warped image 660 and pixel data of respective pixels of the one or more black pixel regions 670 for which the R, G, and B graylevels are zero.

Referring back to FIG. 5A, in one or more embodiments, the image processing circuitry 250 may further include an additional image processing circuit 255 configured to apply one or more other image processes to the resulting image data received from the image warping circuit 400 to generate the processed image data to be provided to the drive circuitry 260. Examples of the image processes that may be performed by the additional image processing circuit 255 include color adjustment (e.g., color gamut adjustment), image scaling, demura correction, deburn correction, gamma transformation, and the like. In other embodiments, the additional image processing circuit 255 may be omitted and the resulting image data generated by the image warping circuit 400 may be used as the processed image data.

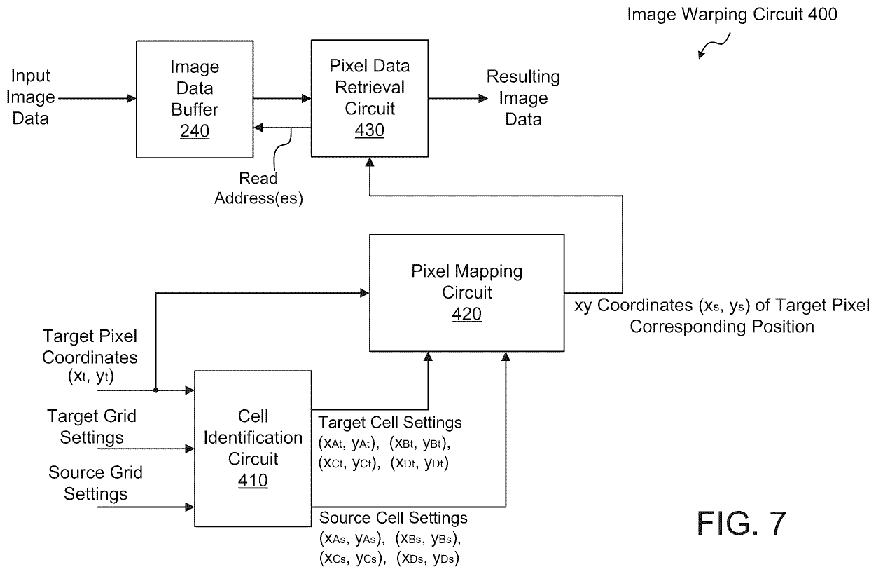

FIG. 7 shows an example configuration of the image warping circuit 400, according to one or more embodiments. In the shown embodiment, the image warping circuit 400 is configured to receive the xy coordinates of the target pixel Pt, target grid settings, and source grid settings to perform the image warping processing. The target pixel is a pixel of the resulting image for which the image warping processing is currently to be performed. The target grid settings indicate the configuration of the target grid (e.g., as shown in FIG. 3), and the source grid settings indicate the configuration of the source grid (e.g., as shown in FIG. 3). In one implementation, the target grid settings may include the xy coordinates of the respective nodes of the target grid, and the source grid settings may include the xy coordinates of the respective nodes of the source grid. In the embodiment shown in FIG. 7, the image warping circuit 400 includes a cell identification circuit 410, a pixel mapping circuit 420, and a pixel data retrieval circuit 430.

The cell identification circuit 410 is configured to identify, based on the xy coordinates (xₜ, yₜ) of the target pixel and target grid settings, the target cell of the warped image in which the target pixel is located and the source cell of the input image that corresponds to the target cell. The cell identification circuit 410 is further configured to extract target cell settings of the target cell from the target grid settings and source cell settings of the corresponding source cell from the source grid settings, and to provide the target cell settings and the source cell settings to the pixel mapping circuit 420. The target cell settings may include the xy coordinates (x_{At}, y_{At}), (x_{Bt}, y_{Bt}), (x_{Ct}, y_{Ct}), and (x_{Dt}, y_{Dt}) of the four nodes defining the target cell, while the source cell settings may include the xy coordinates (x_{As}, y_{As}), (x_{Bs}, y_{Bs}), (x_{Cs}, y_{Cs}), and (x_{Ds}, y_{Ds}) of the four nodes defining the source cell.

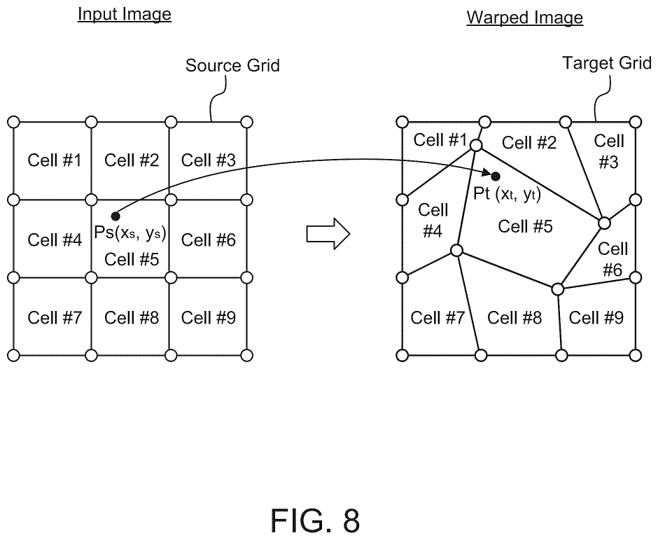

FIG. 8 shows an example identification of the target cell and its corresponding source cell based on the xy coordinates (xₜ, yₜ) of the target pixel and the target grid settings, according to one or more embodiments. In FIG. 8, the white dots indicate the nodes of the source grid and the target grids. In the shown embodiment, based on the target grid settings, which may indicate the xy coordinates of the nodes of the target grid, cell #5 of the warped image is identified as the target cell in which the target pixel Pt is located. Further, cell #5 of the input image, which corresponds to cell #5 of the warped image, is identified as the source cell. The cell identification circuit 410 may be configured to provide the xy coordinates of the four nodes of the target grid that define the target cell and the xy coordinates of the four nodes of the source grid that define the source cell to the pixel mapping circuit 420.

Also referring to FIG. 7, the pixel mapping circuit 420 is configured to determine the “target pixel corresponding position” based on the position of the target pixel in the target cell, the target cell settings, and the source cell settings. As used herein, the “target pixel corresponding position” is the position in the input image that corresponds to the position of the target pixel in the resulting image. In the example of FIG. 8, the target pixel corresponding position, denoted by “Ps”, is located in cell #5 of the input image. In one implementation, the pixel mapping circuit 420 is configured to calculate xy coordinates (xₛ, yₛ) of the target pixel corresponding position in the input image based on the xy coordinates (xₜ, yₜ) of the target pixel, the target cell settings, and the source cell settings. As discussed later, the xy coordinates (xₛ, yₛ) of the target pixel corresponding position are used to select one or more pixels of the source cell to refer to when determining or calculating pixel data of the target pixel. The pixel mapping circuit 420 is further configured to notify the pixel data retrieval circuit 430 of the xy coordinates (xₛ, yₛ) of the target pixel corresponding position.

The pixel data retrieval circuit 430 is configured to generate resulting image data for the resulting image based on the input image data stored in the image data buffer 240 and the xy coordinates (xₛ, yₛ) of the target pixel corresponding position in the input image. For the warped image contained in the resulting image, the pixel data retrieval circuit 430 is configured to retrieve pixel data of one or more selected pixels of the input image from the image data buffer 240 based on the xy coordinates (xₛ, yₛ) to generate pixel data of the target pixel of the warped image. Further, the pixel data retrieval circuit 430 is configured to generate pixel data for each black pixel (e.g., zero R, G, and B graylevels) of the one or more black pixel regions contained in the resulting image.

In some embodiments, the pixel data retrieval circuit 430 may be configured to retrieve pixel data of the single pixel closest to the target pixel corresponding position in the input image from the input image data and to determine the pixel data of the target pixel of the warped image to be the same as the pixel data of the pixel closest to the target pixel corresponding position in the input image. In such embodiments, the pixel data retrieval circuit 430 may be configured to determine a read address for the pixel data of the closest pixel based on the xy coordinates (xₛ, yₛ) of the target pixel corresponding position and to access the image data buffer 240 using the thus determined read address. In other embodiments, the pixel data retrieval circuit 430 may be configured to retrieve pixel data of two or more pixels (e.g., four pixels) located closest to the pixel corresponding position in the input image from the input image data stored in the image data buffer 240 and to determine the pixel data of the target pixel by interpolating the pixel data of the two or more pixels based on the xy coordinates (xₛ, yₛ) of the target pixel corresponding position and the positions of the two or more closest pixels. In such embodiments, the pixel data retrieval circuit 430 may be configured to determine read addresses for the pixel data of the two or more closest pixels based on the xy coordinates (xₛ, yₛ) of the target pixel corresponding position and to access the image data buffer 240 using the thus determined read addresses.

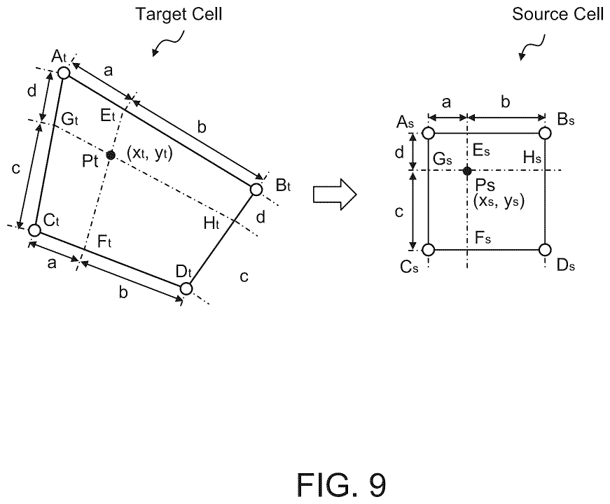

FIG. 9 shows an example calculation of the xy coordinates (xₛ, yₛ) of the target pixel corresponding position, according to one or more embodiments. In FIG. 9, At, Bt, Ct, and Dt are the four nodes defining the target cell (or the four corners of the target cell), and As, Bs, Cs and Ds are the four nodes defining the source cell (or the four corners of the source cell). It is noted that the target cell settings specify the xy coordinates of the nodes At, Bt, Ct, and Dt and the source cell settings specify the xy coordinates of the nodes As, Bs, Cs, and Ds.

In one or more embodiments, calculating the xy coordinates (xₛ, yₛ) includes calculating the ratios a:b and c:d corresponding to the target pixel Pt, wherein the target pixel Pt is located at the intersection between the line segment EtFt and the line segment GtHt, where Et is the point that divides the side AtBt according to the ratio a:b; Ft is the point that divides the side CtDt according to the ratio a:b; Gt is the point that divides the side CtAt according to the ratio c:d, and Ht is the point that divides the side DtBt according to the ratio c:d. It is noted that the side AtBt and the side CtDt are opposite to each other, and the side CtAt and the side DtBt are opposite to each other. The xy coordinates (xₛ, yₛ) of the target pixel corresponding position are determined as the xy coordinates of the intersection of the segment EsFs and the segment GsHs, where Es is the point that divides the side AsBs according to the ratio a:b; Fs is the point that divides the side CsDs according to the ratio a:b; Gs is the point that divides the side CsAs according to the ratio c:d, and Hs is the point that divides the side DsBs according to the ratio c:d. It is noted that the side AsBs and the side CsDs are opposite to each other, and the side CsAs and the side DsBs are opposite to each other. The xy coordinates (xₛ, yₛ) of the target pixel corresponding position can be calculated based on (1) the xy coordinates (xₜ, yₜ) of the target pixel in the resulting image, (2) the xy coordinates (x_{At}, y_{At}), (x_{Bt}, y_{Bt}), (x_{Ct}, y_{Ct}), and (x_{Dt}, y_{Dt}) of the four nodes At, Bt, Ct, and Dt defining the target cell, and (3) the xy coordinates (x_{As}, y_{As}), (x_{Bs}, y_{Bs}), (x_{Cs}, y_{Cs}), and (x_{Ds}, y_{Ds}) of the four nodes As, Bs, Cs, and Ds defining the source cell.

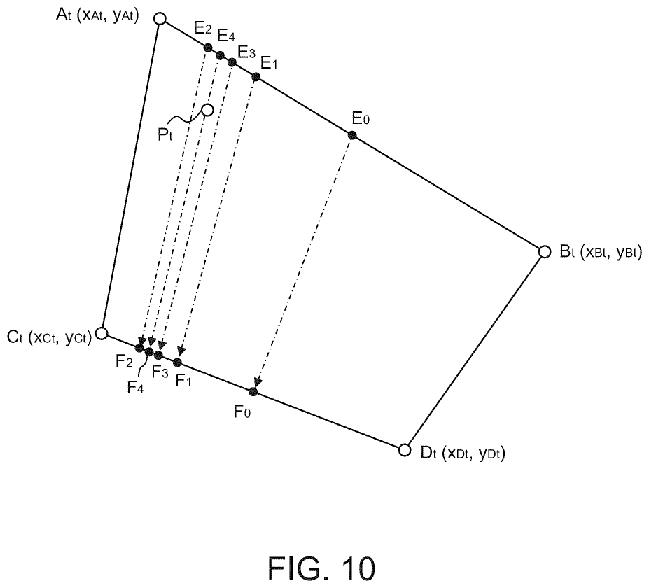

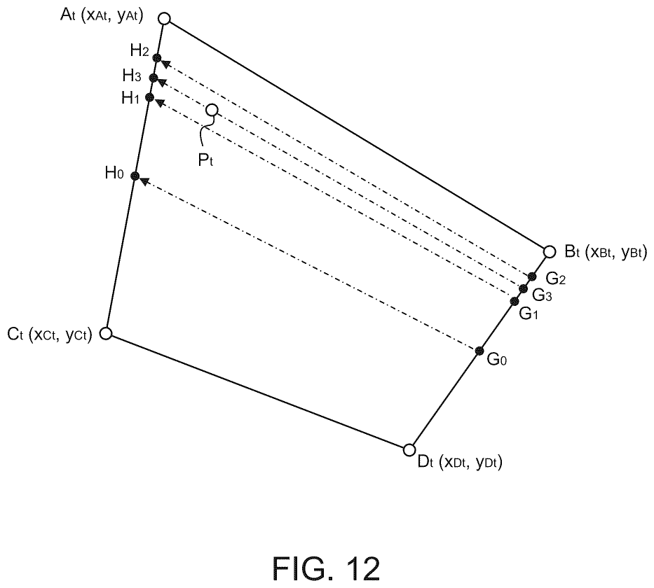

In one or more embodiments, the ratios a:b and c:d may be calculated using a binary search that includes a predetermined number of iterations. FIG. 10 shows an example process for calculating the ratio a:b, according to one or more embodiments, and FIG. 12 shows an example process for calculating the ratio c:d, according to one or more embodiments. In the following, a description is first given of the calculation of the ratio a:b.

In one or more embodiment, as shown in FIG. 10, the calculation of the ratio a:b may begin with determining a midpoint connecting vector \vec{E₀F₀} with the midpoint E₀ of the side AtBt and the midpoint F₀ of the side CtDt. This may be followed by iteratively determining midpoint connecting vectors \vec{E₁F₁}, \vec{E₂F₂}, . . . , \vec{EₙFₙ}, where n is the number of iterations and the midpoint connecting vectors \vec{EₖFₖ} is determined by the k-th iteration for k being any integer between 1 and n inclusive. Shown in FIG. 10 is an example of the determination of the midpoint connecting vectors \vec{E₀F₀} to \vec{E₄F₄}. The ratio a:b is determined to be the ratio AtEₙ:EₙBt (which is equal to the ratio CtFₙ:FₙDt) using the midpoint connecting vector \vec{EₙFₙ}, which is determined by the last iteration.

In one or more embodiments, for k between 1 and n inclusive, the midpoint connecting vector \vec{EₖFₖ} may be determined from the midpoint connecting vector \vec{Eₖ₋₁Fₖ₋₁} as follows. When the target pixel Pt lies to the right of the midpoint connecting vector \vec{Eₖ₋₁Fₖ₋₁}, the midpoint connecting vector \vec{EₖFₖ} is defined to lie to the right of the midpoint connecting vector \vec{Eₖ₋₁Fₖ₋₁} such that Eₖ is the midpoint of the line segment connecting the point Eₖ₋₁ and a first point on the side AtBt, and Fₖ is the midpoint of the line segment connecting the point Fₖ₋₁ and a second point on the side CtDt, where the first point is the closest point to the point Eₖ₋₁ out of the point At (i.e., the corner At) and one or more points of the points E₀ to Eₖ₋₂ which lie to the right of the midpoint connecting vector \vec{Eₖ₋₁Fₖ₋₁}, if such one or more points exist, and the second point is selected from the point Ct (i.e., the corner Ct) and one or more points of the points F₀ to Fₖ₋₂ which lie to the right of the midpoint connecting vector \vec{Eₖ₋₁Fₖ₋₁} (if such one or more points exist). If none of the points E₀ to Eₖ₋₁ lies to the right of the midpoint connecting vector \vec{Eₖ₋₁Fₖ₋₁}, the corner At is selected as the first point. If none of the points F₀ to Fₖ₋₁ lies to the right of the midpoint connecting vector \vec{Eₖ₋₁Fₖ₋₁}, the corner Ct is selected as the second point.

When the target pixel Pt lies to the left of the midpoint connecting vector \vec{Eₖ₋₁Fₖ₋₁}, the midpoint connecting vector \vec{EₖFₖ} is defined to lie to the left of the midpoint connecting vector \vec{Eₖ₋₁Fₖ₋₁} such that Eₖ is the midpoint of the line segment that connects the point Eₖ₋₁ and a third point on the side AtBt, and Fₖ is the midpoint of the line segment that connects the point Fₖ₋₁ and a fourth point on the side CtDt, where the third point is selected from the point Bt (i.e., the corner Bt) and one or more points of the points E₀ to Eₖ₋₂ which lie to the left of the midpoint connecting vector \vec{Eₖ₋₁Fₖ₋₁} (if such one or more points exist), and the fourth point is selected from the point Dt (i.e., the corner Dt) and one or more points of the points F₀ to Fₖ₋₂ which lie to the left of the midpoint connecting vector \vec{Eₖ₋₁Fₖ₋₁} (if such one or more points exist). If none of the points E₀ to Eₖ₋₂ lies to the left of the midpoint connecting vector \vec{Eₖ₋₁Fₖ₋₁}, the corner Bt is selected as the third point. If none of the points F₀ to Fₖ₋₂ lies to the left of the midpoint connecting vector \vec{Eₖ₋₁Fₖ₋₁}, the corner Dt is selected as the fourth point.

Further, when the target pixel Pt lies on the line segment Eₖ₋₁Fₖ₋₁, the midpoint connecting vector \vec{EₖFₖ} is determined to be the same as the midpoint connecting vector \vec{Eₖ₋₁Fₖ₋₁}. It is noted that when the midpoint connecting vector \vec{EₖFₖ} is determined in the above-described manner, the distance between the target pixel Pt and the line segment EₖFₖ is smaller than or equal to the distance between the target pixel Pt and the line segment Eₖ₋₁Fₖ₋₁.

In one or more embodiments, the determination of whether the target pixel Pt lies to the right or left of the midpoint connecting vector \vec{Eₖ₋₁Fₖ₋₁} may be based on the cross product of the vectors \vec{Eₖ₋₁Fₖ₋₁} and \vec{Eₖ₋₁Pₜ}, which is also referred to as \vec{Eₖ₋₁Fₖ₋₁}×\vec{Eₖ₋₁Pₜ}. In one implementation, the cross product \vec{Eₖ₋₁Fₖ₋₁}×\vec{Eₖ₋₁Pₜ} is calculated in accordance with the following expression:

$$\vec{{E}_{k - 1} {F}_{k - 1}} \times \vec{{E}_{k - 1} {P}_{t}} = ( {x}_{F k - 1} - {x}_{E k - 1} ) ( {y}_{t} - {y}_{E k - 1} ) - ( {x}_{t} - {x}_{E k - 1} ) ( {y}_{F k - 1} - {y}_{E k - 1} ) ,$$

where (x_{Ek-1}, y_{Ek-1}) are the xy coordinates of the point Eₖ₋₁, (x_{Fk-1}, y_{Fk-1}) are the xy coordinates of the point Fₖ₋₁, and (xₜ, yₜ) are the xy coordinates of the target pixel Pt. When the cross product \vec{Eₖ₋₁Fₖ₋₁}×\vec{Eₖ₋₁Pₜ} is 0, the target pixel Pt lies on the line segment Eₖ₋₁Fₖ₋₁. When the cross product \vec{Eₖ₋₁Fₖ₋₁}×\vec{Eₖ₋₁Pₜ} is less than 0, the target pixel Pt lies to the right of the midpoint connecting vector \vec{Eₖ₋₁Fₖ₋₁}. When the cross product \vec{Eₖ₋₁Fₖ₋₁}×\vec{Eₖ₋₁Pₜ} is greater than 0, the target pixel Pt lies to the left of the midpoint connecting vector \vec{Eₖ₋₁Fₖ₋₁}.

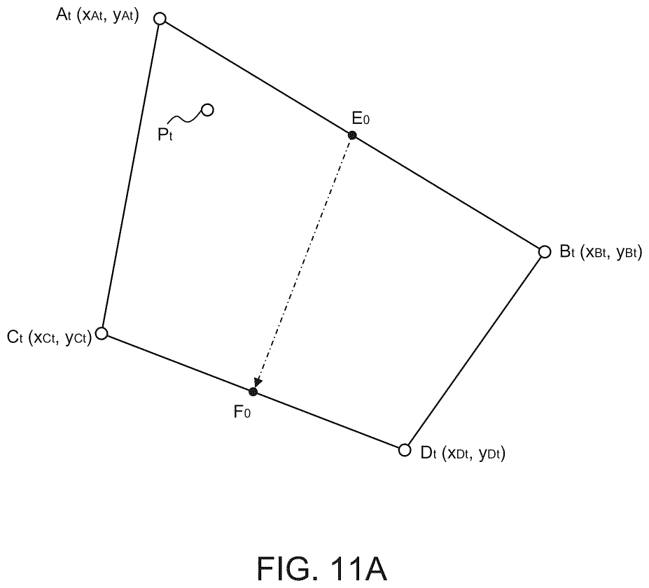

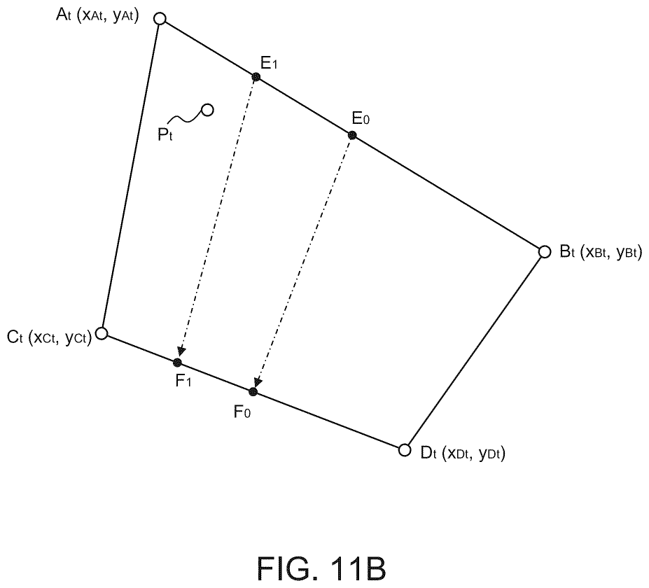

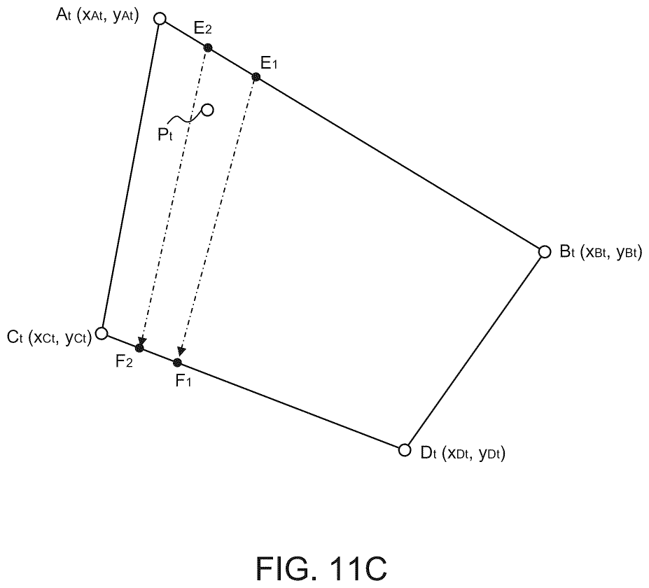

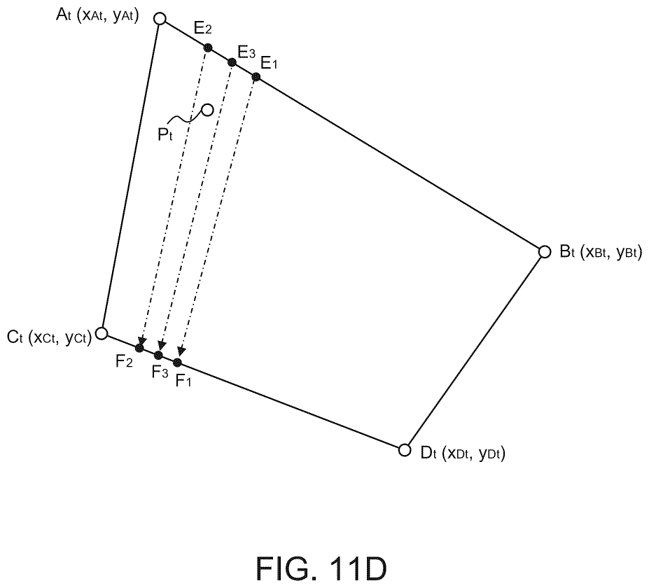

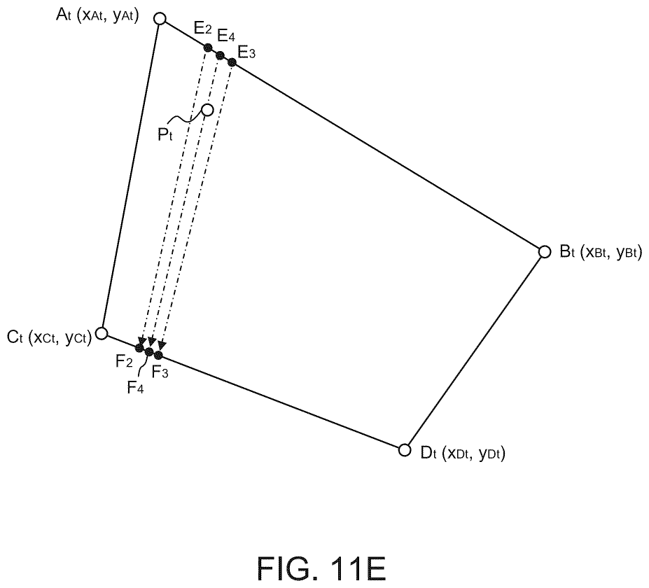

FIG. 11A to 11E shows an example process of determining the midpoint connecting vectors \vec{E₀F₀} to \vec{E₄F₄}, according to one or more embodiments. Initially, as shown in FIG. 11A, the midpoint connecting vector \vec{E₀F₀} is determined with the midpoint E₀ of the side AtBt and the midpoint F₀ of the side CtDt. In iteration #1, since the target pixel Pt lies to the right of the midpoint connecting vector \vec{E₀F₀} as shown in FIG. 11B, the midpoint connecting vector \vec{E₁F₁} is determined with the midpoint E₁ of the line segment AtE₀ and the midpoint F₁ of the line segment CtF₀. In one implementation, the target pixel Pt may be determined to lie to the right of the midpoint connecting vector \vec{E₀F₀} based on the cross product \vec{E₀F₀}×\vec{E₀Fₜ}. In iteration #2, since the target pixel Pt lies to the right of the midpoint connecting vector \vec{E₁F₁} as shown in FIG. 11C, the midpoint connecting vector \vec{E₂F₂} is determined with the midpoint E₂ of the line segment AtE₁ and the midpoint F₂ of the line segment CtF₁. In iteration #3, since the target pixel Pt lies to the left of the midpoint connecting vector \vec{E₂F₂} as shown in FIG. 11D, the midpoint connecting vector \vec{E₃F₃} is determined with the midpoint E₃ of the line segment E₂E₁ and the midpoint F₃ of the line segment F₂F₁. In iteration #4, since the target pixel Pt lies to the right of the midpoint connecting vector \vec{E₃F₃} as shown in FIG. 11E, the midpoint connecting vector \vec{E₄F₄} is determined with the midpoint E₄ of the line segment E₂E₃ and the midpoint F₄ of the line segment F₂F₃. The midpoint connecting vectors \vec{E₄F₄} to \vec{EₙFₙ} may be determined in a similar way. Finally, the ratio a:b is determined to be the ratio AtEₙ:EₙBt.

The number N of the iterations may be determined such that the ratio a:b can be determined with sufficient accuracy. In one or more embodiments, the number N of the iterations may be equal to the bit width of xₜ, yₜ, xₛ, and yₛ, where (xₜ, yₜ) are the xy coordinates of the target pixel and (xₛ, yₛ) are the xy coordinates of the target pixel corresponding point. For example, when xₜ, yₜ, xₛ, and yₛ are each represented by 12 bits, the number N of the iterations may be 12.

In one or more embodiments, the ratio c:d may be determined in a manner similar to the ratio a:b. Referring to FIG. 12, the calculation of the ratio c:d may begin with determining a midpoint connecting vector \vec{G₀H₀}, wherein the midpoint connecting vector \vec{G₀H₀} connects the midpoint G₀ of the side DtBt and the midpoint H₀ of the side CtAt. This is followed by iteratively determining the midpoint connecting vectors \vec{G₁H₁}, \vec{G₂H₂}, . . . , \vec{GₙHₙ}, where n is the number of iterations and the midpoint connecting vectors \vec{GₖHₖ} is determined by the k-th iteration for k being any integer between 1 and n inclusive. FIG. 12 shows examples of the midpoint connecting vectors \vec{G₀H₀} to \vec{G₃H₃}. As described above, the number n of the iterations may be equal to the bit width of xₜ, yₜ, xₛ, and yₛ, where (xₜ, yₜ) are the xy coordinates of the target pixel and (xₛ, yₛ) are the xy coordinates of the target pixel corresponding point. The ratio c:d is acquired as the ratio DtGₙ:GₙBt (which is equal to the ratio CtHₙ:HₙAt) using the midpoint connecting vector \vec{HₙGₙ}, which is determined by the last iteration.

In one or more embodiments, for k between 1 and n inclusive, the midpoint connecting vector \vec{GₖHₖ} may be determined from the midpoint connecting vector \vec{Gₖ₋₁Hₖ₋₁} in a manner similar to the determination of midpoint connecting vector \vec{EₖFₖ} from the midpoint connecting vector \vec{Eₖ₋₁Fₖ₋₁} as follows. When the target pixel Pt lies to the right of the midpoint connecting vector \vec{Gₖ₋₁Hₖ₋₁}, the midpoint connecting vector \vec{GₖHₖ} is defined to lie to the right of the midpoint connecting vector \vec{Gₖ₋₁Hₖ₋₁} such that Gₖ is the midpoint of the line segment that connects the point Gₖ₋₁ and a first point on the side DtBt, and Hₖ is the midpoint of the line segment that connects the point Hₖ₋₁ and a second point on the side CtAt, where the first point is the closest point to the point Gₖ₋₁ out of the point Bt (i.e., the corner Bt) and one or more points of the points G₀ to Gₖ₋₂ which lie to the right of the midpoint connecting vector \vec{Gₖ₋₁Hₖ₋₁}, if such one or more points exist, and the second point is selected from the point At (i.e., the corner At) and one or more points of the points H₀ to Hₖ₋₂ which lie to the right of the midpoint connecting vector \vec{Gₖ₋₁Hₖ₋₁} (if such one or more points exist). If none of the points G₀ to Gₖ₋₁ lies to the right of the midpoint connecting vector \vec{Gₖ₋₁Hₖ₋₁}, the corner Bt is selected as the first point. If none of the points H₀ to Hₖ₋₁ lies to the right of the midpoint connecting vector \vec{Gₖ₋₁Hₖ₋₁}, the corner At is selected as the second point.

When the target pixel Pt lies to the left of the midpoint connecting vector \vec{Gₖ₋₁Hₖ₋₁}, the midpoint connecting vector \vec{GₖHₖ} is defined to lie to the left of the midpoint connecting vector \vec{Gₖ₋₁Hₖ₋₁} such that Gₖ is the midpoint of the line segment that connects the point Gₖ₋₁ and a third point on the side DtBt, and Hₖ is the midpoint of the line segment that connects the point Hₖ₋₁ and a fourth point on the side CtAt, where the third point is selected from the point Dt (i.e., the corner Dt) and one or more points of the points G₀ to Gₖ₋₂ which lie to the left of the midpoint connecting vector \vec{Gₖ₋₁Hₖ₋₁} (if such one or more points exist), and the fourth point is selected from the point Dt (i.e., the corner Dt) and one or more points of the points H₀ to Hₖ₋₂ which lie to the left of the midpoint connecting vector \vec{Gₖ₋₁Hₖ₋₁} (if such one or more points exist). If none of the points G₀ to Gₖ₋₂ lie to the left of the midpoint connecting vector \vec{Gₖ₋₁Hₖ₋₁}, the corner Dt is selected as the third point. If none of the points H₀ to Hₖ₋₂ lie to the left of the midpoint connecting vector \vec{Gₖ₋₁Hₖ₋₁}, the corner Ct is selected as the fourth point.

Further, when the target pixel Pt lies on the line segment Gₖ₋₁Hₖ₋₁, the midpoint connecting vector \vec{GₖHₖ} is determined to be the same as the midpoint connecting vector \vec{Gₖ₋₁Hₖ₋₁}.

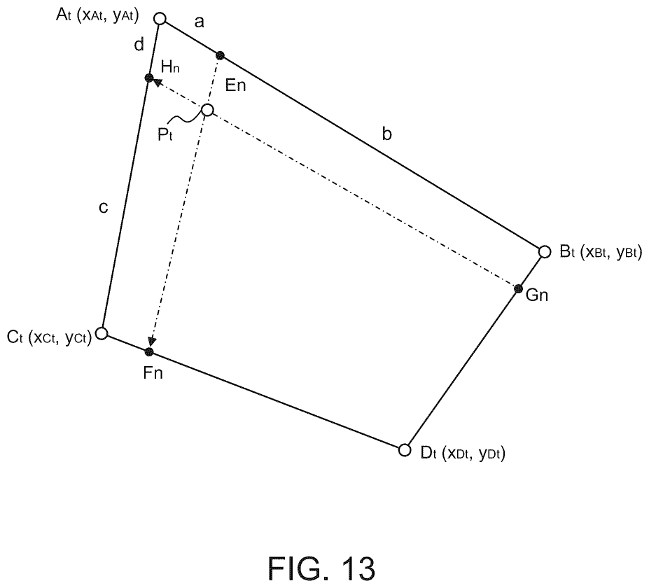

FIG. 13 shows an example determination of the ratios a:b and c:d, according to one or more embodiments. In the shown embodiment, the ratio a:b is determined to be the ratio AtEₙ:EₙBt (which is equal to the ratio CtFₙ:FₙDt), while the ratio c:d is determined to be the ratio DtGₙ:GₙBt (which is equal to the ratio CtHₙ:H_{nAt}). The ratios a:b and c:d thus determined are used to calculate the xy coordinates (xₛ, yₛ) of the target pixel corresponding position, which is the position in the input image that corresponds to the position of the target pixel in the resulting image.

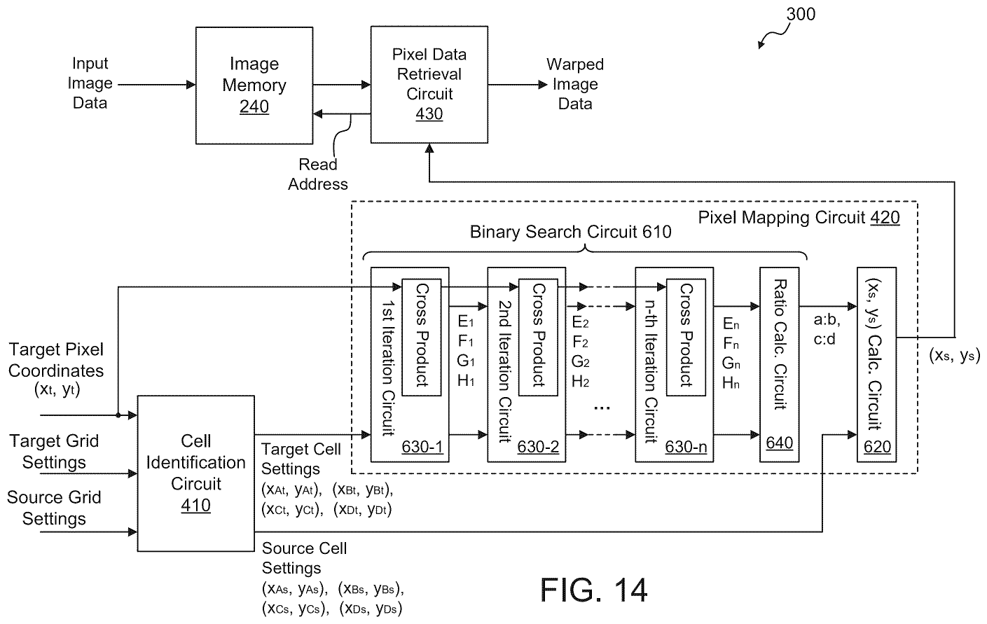

FIG. 14 shows an example configuration of the pixel mapping circuit 420, according to one or more embodiments. In the shown embodiment, the pixel mapping circuit 420 includes a binary search circuit 610 and a target pixel corresponding position calculation circuit 620. The binary search circuit 610 is configured to perform the binary search to determine the ratios a:b and c:d as described above in relation to FIGS. 10 to 13. The target pixel corresponding position calculation circuit 620 is configured to calculate the xy coordinates (xₛ, yₛ) of the target pixel corresponding position based on the ratios a:b and c:d and the xy coordinates (x_{As}, y_{As}), (x_{Bs}, y_{Bs}), (x_{Cs}, y_{Cs}), and (x_{Ds}, y_{Ds}) of the four corners As, Bs, Cs, and Ds of the source cell as described above in relation to FIG. 9. In one or more embodiments, the binary search circuit 610 may include first to n-th serially-coupled iteration circuits 630-1 to 630-n (three shown) and a ratio calculation circuit 640.

The first iteration circuit 630-1 is configured to perform the first iteration of the binary search. More specifically, the first iteration circuit 630 is configured to, as described in relation to FIGS. 10, 11A, and 12, calculate the xy coordinates of the midpoints E₀, F₀, G₀, and H₀ based on the xy coordinates of the target pixel (xₜ, yₜ) and the xy coordinates (x_{At}, y_{At}), (x_{Bt}, y_{Bt}), (x_{Ct}, y_{Ct}), and (x_{Dt}, y_{Dt}) of the four corners At, Bt, Ct, and Dt of the target cell. The xy coordinates of the midpoints E₀, F₀, G₀, and H₀ are used to define the midpoint connecting vector \vec{E₀F₀} and the midpoint connecting vector \vec{G₀H₀}. The first iteration circuit 630-1 is further configured to calculate, as described above in relation to FIGS. 11B and 12, the xy coordinates of the midpoints E₁, F₁, G₁, and H₁ based on the xy coordinates of the target pixel (xₜ, yₜ), the xy coordinates of the midpoints E₀, F₀, G₀, and H₀ and the xy coordinates (x_{At}, y_{At}), (x_{Bt}, y_{Bt}), (x_{Ct}, y_{Ct}), and (x_{Dt}, y_{Dt}) of the four corners At, Bt, Ct, and Dt of the target cell. The xy coordinates of the midpoints E₁, F₁, G₁, and H₁ are used to define the midpoint connecting vector \vec{E₁F₁} and the midpoint connecting vector \vec{G₁H₁}. The first iteration circuit 630-1 may be further configured to provide the xy coordinates of the midpoints E₁, F₁, G₁, and H₁ to the second iteration circuit 630-2.

The second to n-th iteration circuits 630-2 to 630-N are configured to perform second to n-th iterations of the binary search, respectively. For i between two and n inclusive, the i-th iteration circuit 630-i is configured to, as described in relation to FIGS. 10, 11B to 11E, and 12, calculate the xy coordinates of the midpoints Eᵢ, Fᵢ, Gᵢ, and Hᵢ based on the xy coordinates of the target pixel (xₜ, yₜ), the xy coordinates of the midpoints Eᵢ₋₁, Fᵢ₋₁, Gᵢ₋₁, and Hᵢ₋₁ and the xy coordinates (x_{At}, y_{At}), (x_{Bt}, y_{Bt}), (x_{Ct}, y_{Ct}), and (x_{Dt}, y_{Dt}) of the four corners At, Bt, Ct, and Dt of the target cell. The n-th iteration circuit 630-n is further configured to provide the xy coordinates of the midpoints Eₙ, Fₙ, Gₙ, and Hₙ to the ratio calculation circuit 640. The ratio calculation circuit 640 is configured to calculate the ratios a:b and c:d based on the xy coordinates of the midpoints Eₙ, Fₙ, Gₙ, and Hₙ and the xy coordinates (x_{At}, y_{At}), (x_{Bt}, y_{Bt}), (x_{Ct}, y_{Ct}), and (x_{Dt}, y_{Dt}) of the four corners At, Bt, Ct, and Dt of the target cell. The ratios a:b and c:d are provided to the target pixel corresponding position calculation circuit 620, which is configured to calculate the xy coordinates (xₛ, yₛ) of the target pixel corresponding position in the source cell.

Since each of the first to n-th iterations involves only simple arithmetic processes, each of the first to n-th iteration circuits 630-1 to 630-n can be implemented with an efficient circuit structure. This allows the binary search circuit 610 to be implemented with a reduced circuit size, which facilitates performing image warping with reduced hardware resources.

In various embodiments, the image warping circuit 400 (shown in FIGS. 5A and 7) may be configured to generate the resulting image data of the resulting image on a “horizontal line” basis. The “horizontal line” of the resulting image, as referred to herein, is a row of pixels of the resulting image arrayed in the horizontal direction. It is noted that the position of a horizontal line in the resulting image can be represented by a y-coordinate. The “horizontal line” of the resulting image may be displayed as a “horizontal” line on the display panel 220, where the “horizontal” direction on the display panel 220 may be the direction in which a row of pixels 222 coupled to the same gate line 224 (see also FIG. 5B) are arrayed or arranged. In one implementation, pixels of a “horizontal line” of the resulting image may correspond to a row of pixels 222 coupled to the same gate line 224. A row of pixels 222 coupled to a gate line 224 may be driven based on pixel data of the pixels of the corresponding “horizontal line” of the resulting image.

In one or more embodiments, the image warping circuit 400 is configured to generate pixel data of one horizontal line of the resulting image during one line period (or horizontal synchronization period). Here, the horizontal line of the resulting image for which pixel data is first generated in each frame period (or vertical synchronization period) is referred to as the “first horizontal line”, the horizontal line of the resulting image for which pixel data is second generated in each frame period is referred to as the “second horizontal line”, and the same goes for the remaining horizontal lines. Specifically, the horizontal line of the resulting image for which pixel data is N-th generated in each frame period (or vertical synchronization period) is referred to as the “N-th horizontal line”, where N is a natural number between 1 and m inclusive, and m is the number of horizontal lines of the resulting image.

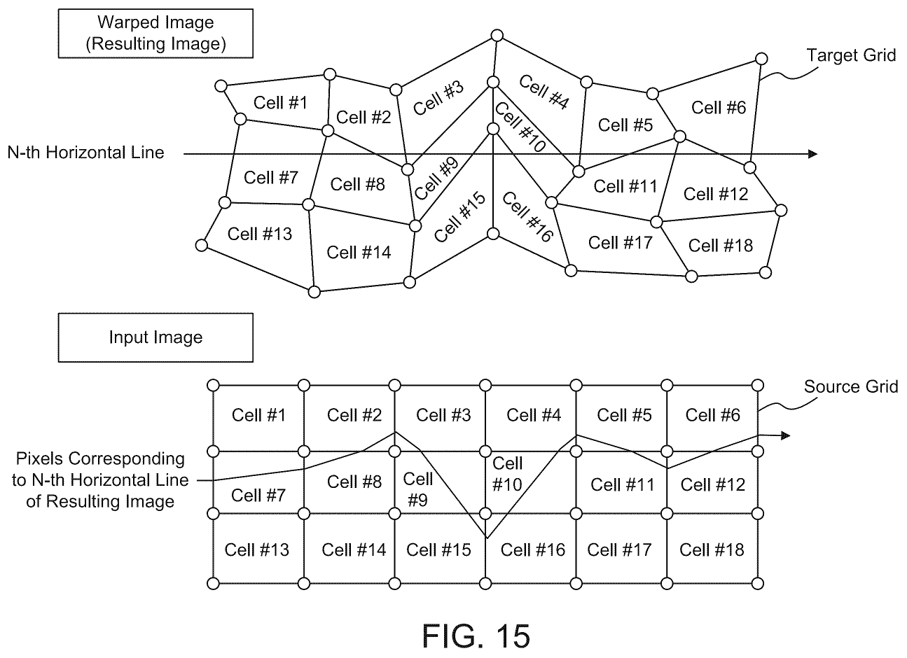

FIG. 15 shows an example of the cell identification performed by the cell identification circuit 410 (shown in FIG. 7) in generating the resulting image data for the N-th horizontal line of the resulting image, which incorporates the warped image, according to one or more embodiments. In generating the resulting image data for the N-th horizontal line, pixels on the N-th horizontal line are sequentially selected as the target pixel and the pixel data of the target pixel is calculated based on pixel data of one or more pixels of the input image selected for the target pixel. As described above, selecting the one or more pixels of the input image includes identifying, based on the xy coordinates (xₜ, yₜ) of the target pixel and target grid settings, the target cell of the resulting image in which the target pixel is located. The present disclosure recognizes that an efficient target cell identification algorithm would be significantly advantageous, because the target grid may not necessarily be defined regularly, and therefore the identified target cell may vary irregularly while the target pixel is sequentially selected from the pixels on the N-th horizontal line. For example, in the example shown in FIG. 15, when the pixels on the N-th horizontal line are scanned from left to right to identify the target cell for each pixel on the N-th horizontal line, the target cell is first identified as cell #7 for a first set of pixels on the N-th horizontal line, then identified as cell #8 for a second set of pixels that lies to the right of the first set of pixels, and then identified as cell #2 for a third set of pixels that lies to the right of the second set of pixels, and so on.

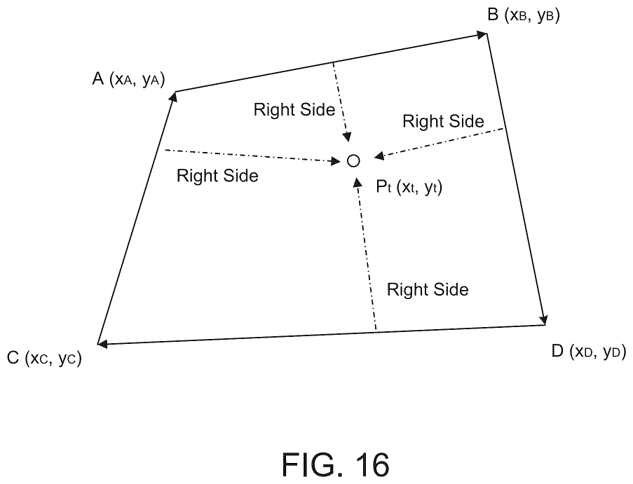

One possible approach to identify the target cell from the cells of the warped image is to use cross products. FIG. 16 shows an example of the target cell identification based on cross products, according to one or more embodiments. For a given cell of the warped image with corners A, B, D, and C defined clockwise in this order, if the target pixel Pt lies to the right of all of the four vectors \vec{AB}, \vec{BD}, \vec{DC}, and \vec{CA} defined for the given cell, this means that the target pixel Pt is located in the cell with the corners A, B, D, and C. In other words, the target pixel Pt is located in the cell with the corners A, B, D, and C if all of the four cross products \vec{AB}×\vec{APt}, \vec{BD}×B̅P̅t̅, \vec{DC}×\vec{DPt}, and \vec{CA}×\vec{CPt} are more than zero, where:

$$\begin{matrix}\vec{AB} \times \vec{APt} = ( {x}_{B} - {x}_{A} ) * ( {y}_{t} - {y}_{A} ) - ( {x}_{y} - {x}_{A} ) * ( {y}_{B} - {y}_{A} ) , \\ \vec{BD} \times \vec{BPt} = ( {x}_{D} - {x}_{B} ) * ( {y}_{t} - {y}_{B} ) - ( {x}_{y} - {x}_{B} ) * ( {y}_{D} - {y}_{B} ) , \\ \vec{DC} \times \vec{DPt} = ( {x}_{C} - {x}_{D} ) * ( {y}_{t} - {y}_{D} ) - ( {x}_{y} - {x}_{D} ) * ( {y}_{C} - {y}_{D} ) , \\ \vec{CA} \times \vec{CPt} = ( {x}_{A} - {x}_{C} ) * ( {y}_{t} - {y}_{C} ) - ( {x}_{y} - {x}_{C} ) * ( {y}_{A} - {y}_{C} ) ,\end{matrix}$$

(xₜ, yₜ) are xy coordinates of the target pixel Pt, and (x_{A}, y_{A}), (x_{B}, y_{B}), (x_{C}, y_{C}), and (x_{D}, y_{D}) are xy coordinates of the corners A, B, C, and D, respectively.

This cell identification method may however require calculation of the cross products described above for each pixel until the target cell is found from the cells of the warped image, which may undesirably increase the required computational effort and the required hardware/software resources, resulting in an undesirable increase in power consumption and/or product cost. In the following, a description is given on embodiments for achieving the cell identification with reduced computational effort and hardware resources.

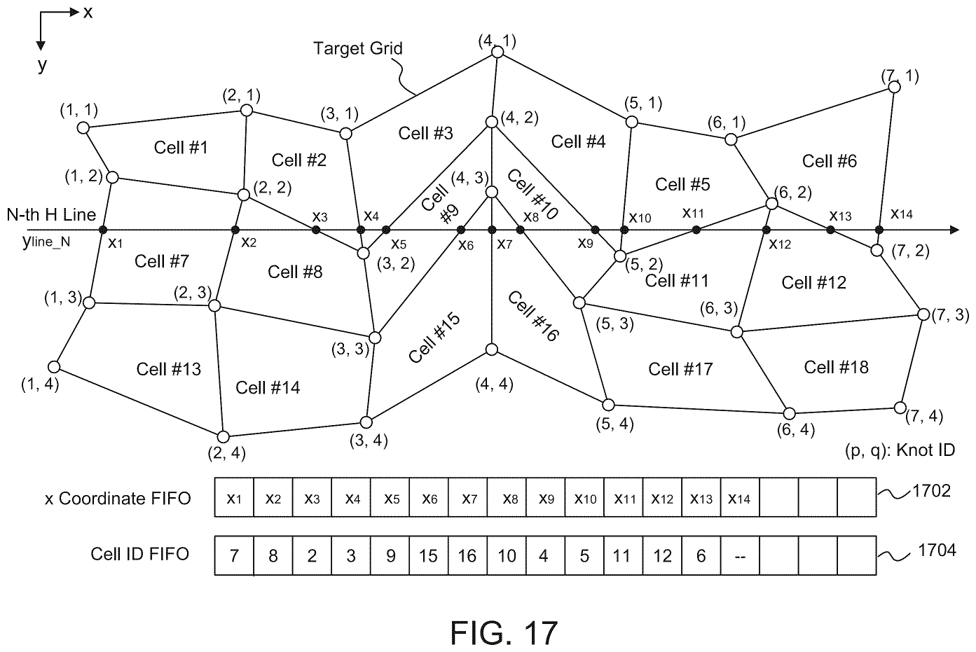

FIG. 17 shows an example of a cell identification method, according to one or more embodiments. In FIG. 17, (p, q) is a node identification (ID) for the node of the target grid located in the p-th row from the top and the q-th column from the left. For example, the node located in the first row from the top and the first column from the left is labeled (1, 1). The line segment connecting two nodes may be referenced by the node IDs of the two nodes. For example, the line segment that connects the nodes (1, 1) and (1, 2) may be referred to as the line segment (1, 1)-(1, 2).

In one or more embodiments, the cell identification circuit 410 may be configured to determine the positions of the intersection points between the N-th horizontal line and the target grid and to use the positions of the intersection points to identify the target cell for each pixel on the N-th horizontal line. In embodiments where the y coordinate of the N-th horizontal line is y_{line_N}, the intersection points between the N-th horizontal line and the target grid may be at the positions with the y coordinate of y_{line_N} on the line segments of the target grid that cross the N-th horizontal line, and the positions of the intersection points can be represented by the x coordinates of the intersection points. In the embodiment shown in FIG. 17, there are 14 intersection points between the N-th horizontal line and the target grid, and the positions of the 14 intersection points can be represented by x coordinates x₁ to x₁₄ of the 14 intersection points. For example, x₁ is the x coordinate of the intersection point between the N-th horizontal line and the line segment (1, 2)-(1, 3), x₂ is the x coordinate of the intersection point between the N-th horizontal line and the line segment (2, 2)-(2, 3), x₃ is the x coordinate of the intersection point between the N-th horizontal line and the line segment (2, 2)-(3, 2), and so on.

The cell identification circuit 410 may be further configured to determine the cell adjacent to each intersection point in the direction in which the pixels on the N-th horizontal line are scanned. In embodiments where the pixels on the N-th horizontal line are scanned in the right direction (i.e., from left to right) when identifying the target cell for each pixel on the N-th horizontal line as shown in FIG. 17, the cell identification circuit 410 may be configured to determine the cell adjacent to the right of each intersection point. For example, the cell identification circuit 410 may be configured to determine that cell #7 is adjacent to the intersection point with the x coordinate of x₁, cell #8 is adjacent to the intersection point with the x coordinate of x₂, cell #2 is adjacent to the intersection point with the x coordinate of x₃, and so on.

The cell identification circuit 410 may be configured to store, in a storage thereof, intersection point information and adjacent cell information. The intersection point information may indicate the positions of the intersection points between the N-th horizontal line and the target grid. The adjacent cell information may indicate the cell adjacent to each intersection point in the direction in which the pixels on the N-th horizontal line are scanned. In one implementation, the storage of the cell identification circuit 410 may include a first first-in-first-out (FIFO), also referred to as an x coordinate FIFO, and a second FIFO, also referred to as a cell ID FIFO. The x coordinate FIFO (or first FIFO) may be configured to store the x coordinates of the intersection points between the N-th horizontal line and the target grid, and the cell ID FIFO (or second FIFO) may be configured to store the cell IDs of the cells adjacent to the respective intersection points. The table 1702 shows an example of the data stored in the x coordinate FIFO while the table 1704 shows an example of the data stored in the cell ID FIFO.

In one or more embodiments, the determining and storing of the positions of the intersection points between the N-th horizontal line and the target grid and the cell adjacent to each intersection point may be performed during a line period (or horizontal synchronization period) prior to the line period during which pixel data for the N-th horizontal line of the resulting image data is generated. In one implementation, the cell identification circuit 410 may be configured to determine and store the positions of the intersection points between the N-th horizontal line and the target grid and the cells adjacent to the respective intersection points during the line period during which pixel data for the (N−1)-th horizontal line is generated. This facilitates pipelining the generation of the resulting image data, thereby improving the efficiency of the image warping processing.

In one or more embodiments, the cell identification circuit 410 may be configured to identify the target cell for each pixel on the N-th horizontal line based on the stored x coordinates of the intersection points between the N-th horizontal line and the target grid stored in the x coordinate FIFO and the stored cell IDs that indicate the cells adjacent to the respective intersection points. In the example shown in FIG. 17, the cell identification circuit 410 may be configured to determine that the pixels on the N-th horizontal line which have x coordinates less than x₁ are located outside of the target grid and that there are no target cells for those pixels. The cell identification circuit 410 may further be configured to determine that the target cell is cell #7 for pixels on the N-th horizontal line which have x coordinates greater than x₁ and less than x₂, cell #8 for pixels on the N-th horizontal line which have x coordinates greater than x₂ and less than x₃, cell #2 for pixels on the N-th horizontal line which have x coordinates greater than x₃ and less than x₄, and so on. Since the calculation of the intersection points and the determination of the cell adjacent to each intersection point can be achieved by efficient arithmetic processing, the target cell identification based on the stored positions of the intersection points between the N-th horizontal line and the target grid and the stored cell IDs of the cells adjacent to the respective intersection points effectively reduces the required hardware resources and power consumption.

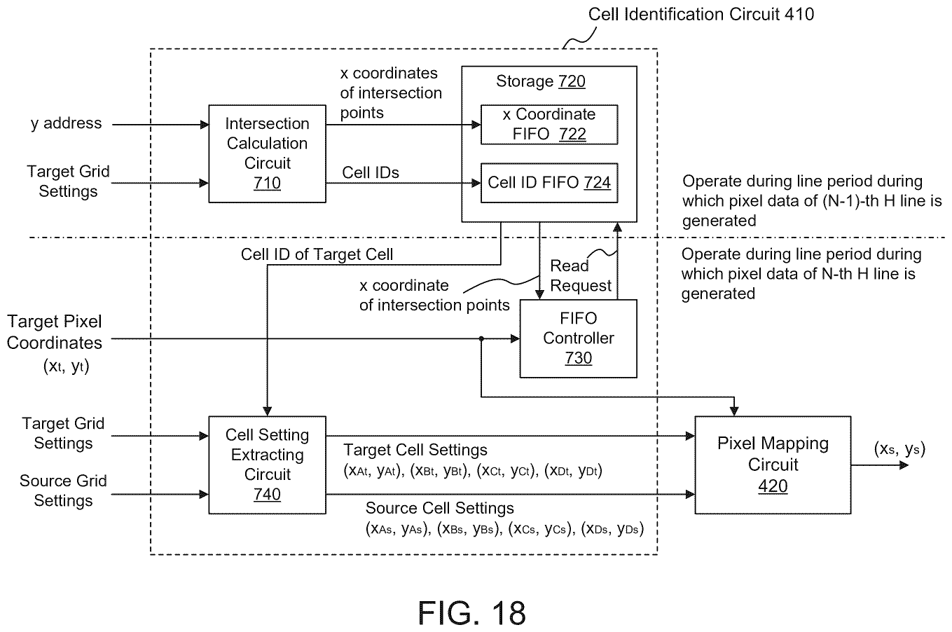

FIG. 18 shows an example configuration of the cell identification circuit 410, according to one or more embodiments. In the shown embodiment, the cell identification circuit 410 includes an intersection calculation circuit 710, a storage 720, a FIFO controller 730, and a cell setting extracting circuit 740. The storage 720 includes an x coordinate FIFO 722 and a cell ID FIFO 724.

The intersection calculation circuit 710 is configured to, during the line period during which pixel data for the (N−1)-th horizontal line of the resulting image data is generated, receive the y address of the N-th horizontal line and the target grid settings and determine the x coordinates of the respective intersection points between the N-th horizontal line and the target grid based on the y address of the N-th horizontal line and the target grid settings. It is noted that the target grid settings may indicate the configuration of the target grid, including the xy coordinates of the respective nodes of the target grid. The intersection calculation circuit 710 is further configured to successively enqueue the x coordinates of the intersection points in the queue of the x coordinate FIFO 722 in the order of the scan of the pixels on the N-th horizontal line to identify the target cell for each pixel. In the example shown in FIG. 17, x₁ is first enqueued in the queue of the x coordinate FIFO 722, then x₂, then x3, and so on. The intersection calculation circuit 710 is further configured to determine the cells adjacent to the respective intersection points in the scanning direction (e.g., the right direction in the embodiment shown in FIG. 17) and successively enqueue the cell IDs of the cells adjacent to the respective intersection points in the queue of cell ID FIFO 724 in the order of determining the cells adjacent to the respective intersection points during the scan of the pixels on the N-th horizontal line. In the example shown in FIG. 17, “7” is first enqueued in the queue of the cell ID FIFO 724, then “8”, then “2”, and so on. The determining and enqueuing of the x coordinates of the intersection points between the N-th horizontal line and the target grid and the cell IDs of the cells adjacent to the respective intersection points are performed during the line period during which pixel data for the (N−1)-th horizontal line of the resulting image data is generated.

The FIFO controller 730 is configured to control accesses to the x coordinate FIFO 722 and the cell ID FIFO 724 based on a comparison between the x coordinate xₜ of the target pixel on the N-th horizontal and the x coordinate received from the x coordinate FIFO 722. In one implementation, the FIFO controller 730 may control the x coordinate FIFO 722 and the cell ID FIFO 724, thereby providing the cell ID of the target cell from the cell ID FIFO 724 to the cell setting extracting circuit 740. In one implementation, the FIFO controller 730 may be configured to operate during target cell identification for the pixels on N-th horizontal line as follows.

At the beginning of the line period during which the pixel data for the N-th horizontal line is generated, the x coordinate at the head of the queue of the x coordinate FIFO 722 is the x coordinate that was first enqueued, which is x₁ in the example shown in FIG. 17. After the start of the line period during which the pixel data for the N-th horizontal line is generated, the x coordinate of the target cell is incremented successively to scan the pixels on the N-th horizontal line. In response to the x coordinate of the target cell exceeding the x coordinate received from the x coordinate FIFO 722 (e.g., x₁), the FIFO controller 730 provides a read request to the cell ID FIFO 724, thereby causing the cell ID FIFO 724 to provide the cell ID at the head of the queue (e.g., “7” in the example shown in FIG. 17) to the cell setting extracting circuit 740 as the cell ID of the target cell. The FIFO controller 730 further causes the x coordinate FIFO 722 to dequeue the x coordinate at the head of the queue, thereby updating the x coordinate at the head of the queue to the x coordinate that was second enqueued in queue of the x coordinate FIFO 722 (e.g., x₂ in the example shown in FIG. 17). The FIFO controller 730 continues to cause the cell ID FIFO 724 to provide the cell ID at the head of the queue (e.g., “7”) until the x coordinate of the target cell exceeds the second enqueued x coordinate (e.g., x₂).

In response to the x coordinate of the target cell exceeding the x coordinate that has been second enqueued (e.g., x₂), the FIFO controller 730 causes the cell ID FIFO 724 to dequeue the cell ID at the head of the queue to thereby update the cell ID at the head of the queue of the cell ID FIFO 724 to the cell ID that has been second enqueued (e.g., “8” in the example shown in FIG. 17). The FIFO controller 730 further provides a read request to the cell ID FIFO 724, thereby causing the cell ID FIFO 724 to provide the updated cell ID at the head of the queue (e.g., “8”) to the cell setting extracting circuit 740 as the cell ID of the target cell. The FIFO controller 730 further causes the x coordinate FIFO 722 to dequeue the x coordinate at the head of the queue, thereby updating the x coordinate at the head of the queue to the third enqueued x coordinate (e.g., x₃ in the example shown in FIG. 17). The FIFO controller 730 continues to cause the cell ID FIFO 724 to provide the cell ID at the head of the queue (e.g., “8”) until the x coordinate of the target cell exceeding the x coordinated that was third enqueued in queue of the x coordinate FIFO 722 (e.g., x₃). A similar process goes on after the x coordinate of the target cell exceeds the x coordinate that has been third enqueued until the target cells are determined for all the pixels on the N-th horizontal line.

The cell setting extracting circuit 740 is configured to extract the target cell settings from the target grid setting based on the cell ID of the target cell received from the cell ID FIFO 724, and to further extract the source cell settings of the source cell corresponding to the target cell from the source grid settings. In one implementation, the target cell settings may include the xy coordinates (x_{At}, y_{At}), (x_{Bt}, y_{Bt}), (x_{Ct}, y_{Ct}), (x_{Dt}, y_{Dt}) of the four corners of the target cell, and the source settings may include the xy coordinates (x_{As}, y_{As}), (x_{Bs}, y_{Bs}), (x_{Cs}, y_{Cs}), (x_{Ds}, y_{Ds}) of the four corners of the source cell. The cell setting extracting circuit 740 is configured to provide the target cell settings and the source cell settings to the pixel mapping circuit 420, which is configured to calculate xy coordinates (xₛ, yₛ) of the target pixel corresponding position in the input image based on the xy coordinates (xₜ, yₜ) of the target pixel, the target cell settings, and the source cell settings.

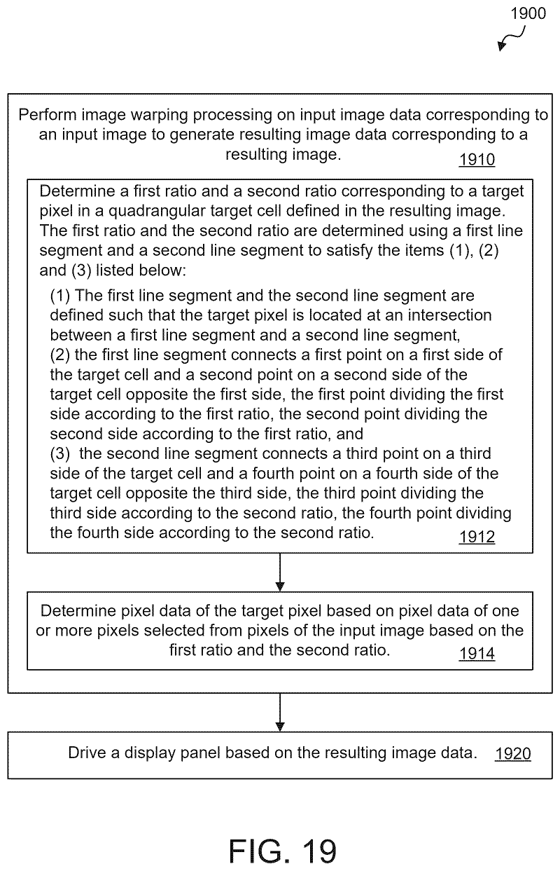

FIG. 19 is a flowchart showing an exemplary process 1900, according to one or more embodiments. The process 1900 may be performed by the display system 100 shown in FIGS. 1, 5A and 5B. However, it will be appreciated that a display system that includes additional and/or fewer components than those shown in FIGS. 1, 5A and 5B may be used to perform the process 1900, that any of the following steps may be performed in any suitable order, and that the process 1900 may be performed in any suitable environment.

The process 1900 includes performing image warping processing on input image data corresponding to an input image to generate resulting image data corresponding to a resulting image (e.g., the resulting image shown in FIG. 6) (1910), and driving the display panel (e.g., the display panel 220 shown in FIG. 5A) based on the resulting image data (1920).

Performing the image warping processing includes determining a first ratio (e.g., “a:b” shown in FIG. 14) and a second ratio (e.g., “c:d” shown in FIG. 14) corresponding to a target pixel (e.g., “Pt” shown in FIGS. 8 and 9) in a quadrangular target cell defined in the resulting image (1912), and determining pixel data of the target pixel based on pixel data of one or more pixels selected from pixels of the input image based on the first ratio and the second ratio (1914). In this procedure, the first ratio and the second ratio are determined using a first line segment (e.g., EtFt shown in FIG. 9) and a second line segment (e.g., GtHt shown in FIG. 9) to satisfy the items (1), (2) and (3) listed below:
(1) The first line segment and the second line segment are defined such that the target pixel is located at the intersection between the first line segment and the second line segment.
(2) The first line segment connects a first point (e.g., Et shown in FIG. 9) on a first side of the target cell and a second point (e.g., Ft shown in FIG. 9) on a second side of the target cell opposite the first side, the first point dividing the first side according to the first ratio, the second point dividing the second side according to the first ratio.
(3) the second line segment connects a third point (e.g., Gt shown in FIG. 9) on a third side of the target cell and a fourth point (e.g., Ht shown in FIG. 9) on a fourth side of the target cell opposite the third side, the third point dividing the third side according to the second ratio, the fourth point dividing the fourth side according to the second ratio.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A display driver, comprising:
an image warping circuit configured to perform image warping processing on input image data corresponding to an input image to generate resulting image data corresponding to a resulting image; and
drive circuitry configured to drive a display panel based on the resulting image data,
wherein performing the image warping processing comprises:
determining a first ratio and a second ratio corresponding to a target pixel in a quadrangular target cell defined in the resulting image, wherein the target pixel is located at an intersection between a first line segment and a second line segment,
wherein the first line segment connects a first point on a first side of the target cell and a second point on a second side of the target cell opposite the first side, the first point dividing the first side according to the first ratio, the second point dividing the second side according to the first ratio, and
wherein the second line segment connects a third point on a third side of the target cell and a fourth point on a fourth side of the target cell opposite the third side, the third point dividing the third side according to the second ratio, the fourth point dividing the fourth side according to the second ratio; and
determining pixel data of the target pixel based on pixel data of one or more pixels selected from pixels of the input image based on the first ratio and the second ratio.

2. The display driver of claim 1, wherein determining the pixel data of the target pixel includes:
determining a target pixel corresponding position in a quadrangular source cell defined in the input image, wherein the target pixel corresponding position is a position of an intersection between a third line segment and a fourth line segment,
wherein the third line segment connects a fifth point on a fifth side of the source cell and a sixth point on a sixth side of the source cell opposite the fifth side, the fifth point dividing the fifth side according to the first ratio, the sixth point dividing the sixth side according to the first ratio,
wherein the fourth line segment connects a seventh point on a seventh side of the source cell and an eighth point on an eighth side of the source cell opposite the seventh side, the seventh point dividing the seventh side according to the second ratio, the eighth point dividing the eighth side according to the second ratio, and
wherein selecting the one or more pixels is based on the target pixel corresponding position.

3. The display driver of claim 1, wherein the image warping circuit is configured to determine the first ratio and the second ratio using a binary search.

4. The display driver of claim 3, wherein the image warping circuit comprises:
a plurality of serially-coupled iteration circuits, wherein each iteration circuit is configured to perform a respective iteration of the binary search, wherein each respective iteration comprises calculation of midpoints located on the first, second, third, and fourth sides of the target cell; and
a ratio calculation circuit configured to calculate the first ratio and the second ratio based on outputs of a final iteration circuit of the serially-coupled iteration circuits.

5. The display driver of claim 1, wherein performing the image warping processing further comprises:
defining a target grid that divides the resulting image into a plurality of cells;
determining positions of intersection points between the target grid and a horizontal line in which the target pixel is located;
storing intersection point information that indicates the positions of the intersection points in a storage; and
identifying the target cell from the plurality of cells based on intersection point information.

6. The display driver of claim 5, wherein the image warping circuit is configured to perform the image warping processing such that the determining of the positions of the intersection points and the storing of the intersection point information are performed in a line period prior to a line period during which pixel data of the resulting image data for pixels on the horizontal line are generated.

7. The display driver of claim 5, wherein performing the image warping processing further comprises:
determining a cell adjacent to each of the intersection points from the plurality of cells; and
storing adjacent cell information that indicates the cell adjacent to each of the intersection points in the storage,
wherein the identifying of the target cell is further based on the adjacent cell information.

8. The display driver of claim 7, wherein the image warping circuit is configured to perform the image warping processing such that the determining of the cell adjacent to each of the intersection points and the storing of the adjacent cell information are performed in a line period prior to a line period during which pixel data of the resulting image data for pixels on the horizontal line are generated.

9. The display driver of claim 1, wherein the drive circuitry is configured to drive the display panel to cause a corrected image corresponding to the resulting image data to be displayed on a curved display screen.

10. A display driver, comprising:
an image warping circuit configured to perform image warping processing on input image data corresponding to an input image to generate resulting image data corresponding to a resulting image; and
drive circuitry configured to drive a display panel based on the resulting image data,
wherein performing the image warping processing comprises:
defining a target grid that divides the resulting image into a plurality of first cells;
defining a source grid that divides the input image into a plurality of second cells that correspond to the plurality of first cells, respectively;
determining positions of intersection points between the target grid and a horizontal line in which a target pixel of the resulting image is located;
storing intersection point information that indicates the positions of the intersection points in a storage;
identifying a target cell in which the target pixel is located from the plurality of first cells based on the intersection point information; and
determining pixel data of the target pixel based on pixel data of the input image data for one or more pixels in a source cell of the plurality of the first cells corresponding to the target cell.

11. The display driver of claim 10, wherein the image warping circuit is configured to perform the image warping processing such that the determining of the positions of the intersection points and the storing of the intersection point information are performed in a line period prior to a line period during which pixel data of the resulting image data for pixels on the horizontal line are generated.

12. The display driver of claim 10, wherein performing the image warping processing further comprises:
determining a cell adjacent to each of the intersection points from the plurality of first cells; and
storing adjacent cell information that indicates the cell adjacent to each of the intersection points in the storage,
wherein the identifying of the target cell is further based on the adjacent cell information.

13. A method comprising:
performing image warping processing on input image data corresponding to an input image to generate resulting image data corresponding to a resulting image; and
driving a display panel based on the resulting image data,
wherein performing the image warping processing comprises:
determining a first ratio and a second ratio corresponding to a target pixel in a quadrangular target cell defined in the resulting image, wherein the target pixel is located at an intersection between a first line segment and a second line segment,
wherein the first line segment connects a first point on a first side of the target cell and a second point on a second side of the target cell opposite the first side, the first point dividing the first side according to the first ratio, the second point dividing the second side according to the first ratio, and
wherein the second line segment connects a third point on a third side of the target cell and a fourth point on a fourth side of the target cell opposite the third side, the third point dividing the third side according to the second ratio, the fourth point dividing the fourth side according to the second ratio; and
determining pixel data of the target pixel based on pixel data of one or more pixels selected from pixels of the input image based on the first ratio and the second ratio.

14. The method of claim 13, wherein determining the pixel data of the target pixel includes:
determining a target pixel corresponding position in a quadrangular source cell defined in the input image, wherein the target pixel corresponding position is a position of an intersection between a third line segment and a fourth line segment,
wherein the third line segment connects a fifth point on a fifth side of the source cell and a sixth point on a sixth side of the source cell opposite the fifth side, the fifth point dividing the fifth side according to the first ratio, the sixth point dividing the sixth side according to the first ratio,
wherein the fourth line segment connects a seventh point on a seventh side of the source cell and an eighth point on an eighth side of the source cell opposite the seventh side, the seventh point dividing the seventh side according to the second ratio, the eighth point dividing the eighth side according to the second ratio, and
wherein selecting the one or more pixels is based on the target pixel corresponding position.

15. The method of claim 13, wherein a binary search is used to determine the first ratio and the second ratio.

16. The method of claim 13, wherein performing the image warping processing further comprises:
defining a target grid that divides the resulting image into a plurality of cells;
determining positions of intersection points between the target grid and a horizontal line in which the target pixel is located;
storing intersection point information that indicates the positions of the intersection points in a storage; and
identifying the target cell from the plurality of cells based on intersection point information.

17. The method of claim 16, wherein the determining of the positions of the intersection points and the storing of the intersection point information are performed in a line period prior to a line period during which pixel data of the resulting image data for pixels on the horizontal line are generated.

18. The method of claim 16, wherein performing the image warping processing further comprises:
determining a cell adjacent to each of the intersection points from the plurality of cells; and
storing adjacent cell information that indicates the cell adjacent to each of the intersection points in the storage,
wherein the identifying of the target cell is further based on the adjacent cell information.

19. The method of claim 18, wherein the determining of the cell adjacent to each of the intersection points and the storing of the adjacent cell information are performed in a line period prior to a line period during which pixel data of the resulting image data for pixels on the horizontal line are generated.

20. The method of claim 13, wherein the driving of the display panel causes a corrected image corresponding to the resulting image data to be displayed on a curved display screen.
